(19) United States
(12) Patent Application Publication
(10) Pub. No.: US 2013/0318196 A1
(43) Pub. Date: Nov. 28, 2013

(54) STORAGE SYSTEM AND STORAGE CONTROL METHOD FOR USING STORAGE AREA BASED ON SECONDARY STORAGE AS CACHE AREA

(71) Applicants: Akira Yamamoto, Sagamihara (JP); Hideo Saito, Yokohama (JP); Yoshiaki Eguchi, Yokohama (JP); Masayuki Yamamoto, Sagamihara (JP); Noboru Morishita, Yokohama (JP)

(72) Inventors: Akira Yamamoto, Sagamihara (JP); Hideo Saito, Yokohama (JP); Yoshiaki Eguchi, Yokohama (JP); Masayuki Yamamoto, Sagamihara (JP); Noboru Morishita, Yokohama (JP)

(73) Assignee: Hitachi, Ltd.

(21) Appl. No.: 13/514,437

(22) PCT Filed: May 23, 2012
(86) PCT No.: PCT/JP2012/003371

§ 371 Date: Jun. 7, 2012

(51) Int. Cl. G06F 15/167

(52) U.S. Cl. 709/215

(57) ABSTRACT

In general, a DRAM is used as a cache memory, and when attempting to expand the capacity of the cache memory to increase the hit ratio, the DRAM is required to be physically augmented, which is not a simple task. Consequently, a storage system uses a page, which conforms to a capacity virtualization function (for example, a page allocatable to a logical volume in accordance with Thin Provisioning), as a cache area. This makes it possible to dynamically increase and decrease the cache capacity.

### TECHNICAL FIELD

The present invention relates to technology for using a storage area based on a secondary storage as a cache area.

### BACKGROUND ART

Recent storage systems comprise a myriad of storage functions. There are also storage vendors who provide these storage functions for a fee, and in this regard, increasing the performance of storage functions is considered valuable for storage vendor customers. In addition, the performance of a flash memory device is superior to that of a magnetic disk device or other such disk storage device, and with flash memory prices becoming less expensive recently, flash memory devices are increasingly being mounted in storage systems in place of disk storage devices. A storage system generally comprises a cache memory (for example, a DRAM (Dynamic Random Access Memory)), and frequently accessed data stored in a secondary storage, such as either a flash memory apparatus or a disk storage, is stored in the cache memory.

Due to the characteristics of the flash memory, when attempting to rewrite data, the flash memory device cannot directly overwrite this data on the physical area in which this data was originally stored. When carrying out a data write to an area for which a write has already been performed, the flash memory device must write the data after executing a deletion process in a unit called a block, which is the deletion unit of the flash memory. For this reason, when rewriting data, the flash memory device most often writes the data to a different area inside the same block rather than writing the data to the area in which it was originally stored. When the same data has been written to multiple areas and a block is full of data (when there are no longer any empty areas in the block), the flash memory device creates an empty block by migrating the valid data in the block to another block and subjecting the migration-source block to a deletion process.

When adopting a system, which fixedly allocates an address for storing data, the rewrite frequency normally differs for each address, resulting in the occurrence of variations in the number of deletions for each block. There is a limit on the number of times that the respective blocks of a flash memory can be deleted, and it is ordinarily not possible to store data in a block, which has exceeded the limit on the number of deletions. To solve for the above problem, a technique called wear leveling has been disclosed (for example, Patent Literature 1) as a technique for lessening these variations. The basic concept behind wear leveling is to reduce a bias in the number of deletions of a physical block in accordance with providing a logical address layer, which is separate from a physical address, as the address layer shown outwardly, and changing as needed a logical address, which is allocated to the physical address (for example, allocating an address with a small number of deletions to a frequently accessed logical address). Since the logical address remains the same even when the physical address changes, outwardly, data can be accessed using the same address. Usability can thus be maintained.

Next, storage capacity reduction technology will be described. In recent years, attention has been focused on technology for reducing storage capacity in a storage system. One typical such technology is capacity virtualization technology. Capacity virtualization technology is technology for showing a host a virtual capacity, which is larger than the physical capacity possessed by the storage system. This makes use of the characteristic that, relative to the capacity of a user volume, which is a user-defined logical volume (the storage seen by the user), the amount of data actually stored seldom reaches this defined capacity (the capacity of the user volume). That is, whereas, when there is no capacity virtualization technology, the defined capacity is reserved from a storage space (hereinafter, physical space) provided by a secondary storage device group of the storage system at volume definition time, when capacity virtualization technology is applied, the capacity is reserved when data is actually stored. This makes it possible to reduce the storage capacity (the capacity reserved from the physical space), and, in addition, makes it possible to enhance usability since a user may simply define a value, which provides plenty of leeway, rather than having to exactly define the user volume capacity. In this technology, the physical storage area reserved when data has been written is called, for example, a “page”. Generally speaking, the size of a page is highly diverse, but in the present invention, it is supposed that the size of the page is larger than the size of the block, which is the flash memory deletion unit. However, in a flash memory, the unit for reading/writing data from/to a block is generally called a page in relation to the deletion unit, which is called a block as was explained hereinabove. Naturally, in the flash memory, the size of the block is larger than the size of the page. However, in the present invention, it is supposed that the term “page” refers to a page in capacity virtualization, and does not refer to the read/write unit of the flash memory. In this regard, in the present invention, it is supposed that the above-mentioned capacity virtualization technology is being applied in a storage system.

A technology for migrating data in a page in page units between storages (typically, HDDs (Hard Disk Drives)) and realizing enhanced performance in a storage system in which capacity virtualization technology is applied has been disclosed (for example, Patent Literature 2). In addition, technology for migrating data between pages based on storages having different price-performance ratios and enhancing the price-performance ratio has also been disclosed.

Meanwhile, technology for balancing the number of flash memory rewrites among the respective storages in a storage system, which couples together multiple flash memory devices and has capacity virtualization technology (local wear leveling), and, in addition, balances the number of rewrites between multiple storages comprising a flash memory device in accordance with migrating data between pages (global wear leveling) has been disclosed (for example, Patent Literature 3).

Alternatively, in a storage system comprising a disk device and a flash memory device, technology for using a portion of an area of a flash memory device as a caching memory for data, which is stored in a disk device, and for using another area in this flash memory device as an area for permanently storing data has been disclosed (for example, Patent Literature 4).

In a file-level file storage system, technology for caching core-side file storage system data in an edge-side file storage system close to a server using a hierarchy configuration provided via a network has also been disclosed (for example, Patent Literature 5).

Furthermore, in an environment in which multiple data centers have storage systems respectively coupled to a wide-area network and the storage systems at a number of data centers possess replications of logical volumes, technology by which the data center to which a user logs in is decided based on the location of the user terminal and the access-destination logical volume, and the data center storage system with the replicate of the access-destination logical volume remote copies data between the logical volume and this replicate has also been disclosed (for example, Patent Literature 6).

Technology by which multiple storage systems are provided as a single virtual storage system in accordance with multiple storage systems comprising the same virtual storage identifier has also been disclosed (for example, Patent Literature 7).

### CITATION LIST

### Patent Literature

PTL 1: Japanese Patent Publication No. 3507132
PTL 2: Japanese Patent Application Publication No. 2005-301627
PTL 3: WO 2011/010344
PTL 4: Japanese Patent Application Publication No. 2009-043030
PTL 5: Japanese Patent Application Publication No. 2010-097359
PTL 6: Japanese Patent Publication No. 04208506
PTL 7: Japanese Patent Application Publication No. 2008-040571

### SUMMARY OF INVENTION

### Technical Problem

A first problem is to efficiently use an area based on one part of a secondary storage (for example, at least one of a flash memory device or a disk device) as a cache area in a single storage system. A second problem is to efficiently use an area based on one part of the secondary storage (for example, at least one of a flash memory device or a disk device) as a cache area in multiple storage systems for storing data stored in another storage system.

The first problem will be described first. (1) Firstly, caching has no effect unless a hit ratio (the probability that the data being accessed exists in the cache) is equal to or larger than a fixed value, and as such, this hit ratio must be maintained at equal to or larger than a certain value. (2) Next, in a case where an area based on one part of a secondary storage (for example, at least one of a flash memory device or a disk device) is used as a cache area, the load on the cache area and an area other than this cache area (for example, an area, which permanently stores data) must be well controlled. (3) Additionally, in a case where an area based on a flash memory device is used as the cache memory, the number of rewrites to the cache area and the number of rewrites to an area other than this cache area (for example, an area, which permanently stores data) must be balanced. (4) Generally speaking, the rule is that a storage having a cache area features higher performance than a storage comprising a storage area in which permanent data is stored. Therefore, using a flash memory device as a cache area for caching data, which is permanently stored in a disk device, is effective. Also, disk devices include high-speed disk devices (a disk device with a fast access speed) and low-speed disk devices (a disk device with a slow access speed), and using a high-speed disk device as the cache area for caching data stored permanently in a low-speed disk device has a certain effect.

The second problem will be explained. The second problem shares (1), (2), and (3) explained in relation to the first problem in common with the first problem. The above (4) differs. In the second problem, caching is performed for data stored in a storage of another storage system. (5) In general, a host or a server issues either a read request or a write request to a storage system in which data is being permanently stored. However, to perform caching in a certain storage system, this storage system must be configured to receive a read request/write request from a server. (6) When caching the data on another storage system, the time required to transfer the data from the storage system where the data is being permanently stored to the caching storage system (the cache transfer time) is linked to shortening the response time for the server from when the read request was issued until a response is received. For this reason, this cache transfer time must be taken into account when carrying out caching.

### Solution to Problem

Means for solving the first problem will be explained.

To ensure a sufficient hit ratio in the (1) above, the storage system allocates a page, which is utilized in a capacity virtualization function, to a cache area based on a secondary storage. In general, a DRAM is used as a cache memory, and when attempting to expand the capacity of the cache memory to increase the hit ratio, the DRAM must be physically augmented, which is not a simple task.

Alternatively, when the storage system possesses a capacity virtualization function for allocating a page based on a secondary storage for permanently storing data to a logical volume (a virtual logical volume), the page can only be allocated to a data write-destination logical area (an area in the logical volume). For this reason, a relatively large number of empty pages may exist in the storage system.

Consequently, an empty page is used as the cache area. Specifically, for example, a logical volume, which is provided in accordance with the capacity virtualization function, is used as a cache volume to which a cache area (page) is to be allocated. Each time the cache capacity (the actual capacity of the cache volume) is expanded, a page is allocated to the cache volume. In accordance with this, the cache capacity (the total capacity of the cache areas (pages) allocated to the cache volume) can be easily expanded, thereby enabling the hit ratio to be improved.

In a case where the hit ratio does not improve that much even though the cache capacity has been increased, the storage system can relatively easily reduce the cache capacity by releasing a page from the cache volume.

In (2) above, in a case where an area based on one part of a secondary storage (for example, at least one of a flash memory device or a disk device) is used as the cache area, the storage system, in order to suitably balance the load on an area other than the cache area (for example, an area, which permanently stores data), monitors the load between pages and balances the load between the storages. In a case where the storage system comprises a storage hierarchy configuration comprising multiple storages having different performances, the storage system transfers data, which is in a page, between storage tiers, but restricts the transfer destination of data in a cache page, which is the page used as the cache area, solely to a page based on a secondary storage with better performance than the secondary storage for permanently storing data.

Generally speaking, there is cache management information for each area in a cache memory such as a DRAM, and in a case where the storage system transfers data from an area, the storage system must rewrite the cache management information corresponding to this area. This results in a large overhead.

Consequently, the cache management information denotes the area in the cache volume to which a page has been allocated. In accordance with this, the storage system does not have to rewrite the cache management information even when transferring data between pages.

In (3) above, in a case where the cache area is an area based on a flash memory device, the flash memory device executes wear leveling locally, and the storage system balances the number of rewrites among multiple flash memory devices by transferring data in a page between different flash memory devices.

In (4) above, the storage system selects a secondary storage, which is faster than the secondary storage storing data permanently, as the secondary storage to serve as the basis of the cache area.

Means for solving the second problem will be explained.

In (5) above, the virtual storage system is configured to possess all of the ports possessed by the individual storage systems for making multiple storage systems appear to be a single virtual storage system, and, in addition, for receiving either a read request or a write request. The caching storage system can receive either a read request or a write request for the storage system, which permanently stores data, by notifying the host (for example, a server) to change the virtual storage system port for receiving either the read request or the write request.

In (6) above, first, in a case where caching is performed for data in the storage system, which permanently stores data, a decision is made as to which secondary storage of which storage system comprising the virtual storage system is to serve as the basis for the area for which caching is to be performed. This decision is made based on the effect to be obtained by the host in accordance with carrying out caching. This effect can reduce the time for transferring data to a storage system in a case where the access-source host of this data is located far away from the storage system in which the data is being stored by carrying out caching in a storage system, which is close to the host. Caching has a big effect in a case where the distance between storage systems is long and the storage systems are connected via a network with a long latency time. For this reason, caching is effective even when performed in a secondary storage having the same performance as the secondary storage in which data is stored permanently. In some cases, the caching effect can be expected even when caching data in a secondary storage with performance somewhat lower than the secondary storage in which data is stored permanently. For this reason, caching must be performed by taking into account the data transfer time between storage systems.

### Advantageous Effects of Invention

Caching data in a cache area, which is an area based on one part of a secondary storage (for example, at least one of a flash memory device or a disk device) can be carried out effectively inside a single storage system or between different storage systems, thereby making it possible to realize higher performance.

### BRIEF DESCRIPTION OF DRAWINGS

FIG. 1 is a diagram showing the configuration of an information system in Example 1.

FIG. 2 is a diagram showing the configuration of a storage system in Example 1.

FIG. 3 is a diagram showing information stored in a common memory of the storage system in Example 1.

FIG. 4 is a diagram showing the format of logical volume information in Example 1.

FIG. 5 is a diagram showing the format of schedule information in Example 1.

FIG. 6 is a diagram showing the format of real page information in Example 1.

FIG. 7 is a diagram denoting the relationships among virtual pages, real pages, virtual blocks, and real blocks in Example 1.

FIG. 8 is a diagram denoting a set of real page information, which is in an empty state, pointed to by an empty page management information pointer in Example 1.

FIG. 9 is a diagram showing the format of storage group information in Example 1.

FIG. 10 is a diagram showing the format of storage information in Example 1.

FIG. 11 is a diagram showing the format of cache management information in Example 1.

FIG. 12 is a diagram denoting the structures of a LRU slot queue and a LRU segment queue in Example 1.

FIG. 13 is a diagram showing the configurations of an empty slot queue, an empty segment queue, and an ineffective segment queue in Example 1.

FIG. 14 is a diagram denoting the format of slot management information in Example 1.

FIG. 15 is a diagram denoting the format of segment management information in Example 1.

FIG. 16 is a diagram denoting the format of hit ratio information in Example 1.

FIG. 17 is a diagram showing programs stored in the memory of a storage controller in Example 1.

FIG. 18 is a diagram showing the flow of processing of a read process execution part in Example 1.

FIG. 19 is a diagram showing the flow of processing of a write request receive part in Example 1.

FIG. 20 is a diagram showing the flow of processing of a slot obtaining part in Example 1.

FIG. 21 is a diagram showing the flow of processing of a segment obtaining part in Example 1.

FIG. 22 is a diagram denoting the configuration of another information system of Example 1.

FIG. 23 is a diagram showing the configuration of a DRAM cache in Example 1.

FIG. 24 is a diagram showing the flow of processing of a transfer page schedule part in Example 1.

FIG. 25 is a diagram showing the flow of processing of a real page transfer process execution part in Example 1.

FIG. 26 is a diagram showing the flow of processing of a storage selection part in Example 1.

FIG. 27 is a diagram showing the flow of processing of a cache capacity control part in Example 1.

FIG. 28 is a diagram denoting the configuration of an information system of Example 2.

FIG. 29 is a diagram denoting the configuration of another information system of Example 2.

FIG. 30 is a diagram showing information stored in the common memory of a storage system in Example 2.

FIG. 31 is a diagram showing virtual storage system information in Example 2.

FIG. 32 is a diagram showing external logical volume information in Example 2.

FIG. 33 is a diagram showing logical volume information in Example 2.

FIG. 34 is a diagram showing the flow of processing of a caching judge processing part in Example 2.

FIG. 35 is a diagram showing the flow of processing of a read process execution part in Example 2.

FIG. 36 is a diagram showing the flow of processing of a write request receive part in Example 2.

FIG. 37 is a diagram showing the flow of processing of a storage selection part in Example 2.

FIG. 38 is a diagram showing the flow of processing of a segment obtaining part in Example 2.

FIG. 39 is a diagram showing the format of port information in Example 2.

FIG. 40 is a diagram showing the format of host information in Example 2.

FIG. 41 is a diagram showing the programs stored in the memory of the storage controller in Example 2.

FIG. 42 is the flow of processing of latency send part in Example 2.

### DESCRIPTION OF EMBODIMENTS

A number of examples will be explained hereinbelow by referring to the drawings.

### Example 1

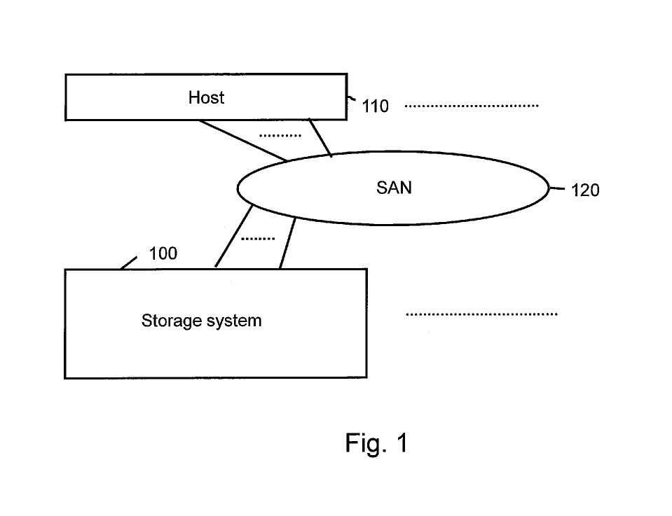

FIG. 1 shows the configuration of an information system in Example 1.

The information system comprises a storage system 100 and a host 110, and these are connected, for example, via a communication network such as a SAN (Storage Area Network) 120. The host 110 uses a system for running a user application to read/write required data from/to the storage system 100 via the SAN 120. In the SAN 120, for example, a protocol such as Fibre Channel is used as a protocol enabling the transfer of a SCSI command.

This example relates to a storage system, which uses a storage area based on a portion of a flash memory device and a portion of a disk device as a cache area, and a control device and a control method for this storage system. In Example 1, the storage system uses a storage area based on a portion of a flash memory device and a portion of a disk device as a cache area for permanently stored data. High performance is achieved in accordance with this. The storage area, which is capable of being used as a cache area, is a storage area based on a secondary storage with higher performance than the secondary storage, which constitutes the basis of the storage area in which data is being stored permanently. Since caching is not effective unless the hit ratio (the probability that the data to be accessed exists in the cache area) is equal to or larger than a fixed value, the hit ratio must be maintained at equal to or larger than a certain value. In this example, to ensure a sufficient hit ratio, a capacity virtualization function is used in relation to data caching. Specifically, a logical volume (typically, a virtual logical volume, which conforms to Thin Provisioning) is provided as the area in which data is to be cached, and a page is allocated to this logical volume (hereinafter, cache volume) as the cache area.

Generally speaking, a DRAM or other such volatile memory is used as the cache area, but expanding the capacity of the cache area to increase the hit ratio is not that simple, requiring physical augmentation in order to increase the DRAM. Alternatively, in the case of a storage, which stores data permanently, ordinarily a page is only allocated to a data write-destination area when there is a capacity virtualization function, and as such, a relatively large number of empty pages can exist in the storage system.

In this example, an empty page is used as the cache area. For this reason, the cache capacity can be expanded relatively easily by dynamically allocating pages to the cache volume for the purpose of enhancing the hit ratio. Alternatively, in a case where the hit ratio is not improved much even though the cache capacity has been increased, the cache capacity can be decreased relatively easily by releasing a page from the cache volume.

Next, in a case where a storage area based on a portion of a flash memory device and a portion of a disk device is used as the cache area, the load on the storage in which data is being stored permanently must be suitably controlled. In this example, a mechanism for monitoring the load between pages and balancing the load between storages is used for this load control. In a case where the storage system comprises a storage hierarchy configuration comprising multiple storages of different performances, this mechanism transfers data from a page in a certain tier to a page in a different tier, but the transfer destination of data in a page being used as the cache area is restricted solely to a page based on a secondary storage with higher performance than the secondary storage for storing data permanently. One or more secondary storages having the same performance (substantially the same access performance) belong to one storage tier.

Generally speaking, there is cache management information for each area in DRAM cache memory, and the storage system, in a case where data has been transferred from an area, must rewrite the cache management information corresponding to this area. This results in a large overhead.

Consequently, the cache management information denotes the area in the cache volume to which a page has been allocated. In accordance with this, the storage system does not have to rewrite the cache management information even when transferring data between pages.

In addition, in a case where an area based on a flash memory device is used as the cache area, the number of rewrites to the cache area and the number of rewrites to an area other than this cache area (for example, an area in which permanent data has been stored) must be balanced.

Consequently, in a case where the cache area is an area based on a flash memory device, the flash memory device executes wear leveling locally in its own device, and the storage system transfers data, which is in a page, between different flash memory devices. In accordance with this, the number of rewrites is balanced between multiple flash memory devices. In addition, the storage system can also balance the number of empty blocks in multiple flash memory devices by transferring data, which is in a page, between the flash memory devices.

Generally speaking, as a rule, a storage having a cache area has higher performance than a storage comprising a storage area in which permanent data is stored. Therefore, using a flash memory device as a cache area for caching data, which is permanently stored in a disk device, is effective. Also, disk devices include high-speed disk devices (a disk device with a fast access speed) and low-speed disk devices (a disk device with a slow access speed), and using a high-speed disk device as the cache area for caching data stored permanently in a low-speed disk device has a certain effect.

Consequently, in this example, the storage system selects a secondary storage, which is faster than the secondary storage in which data is stored permanently, as the secondary storage on which to base the cache area.

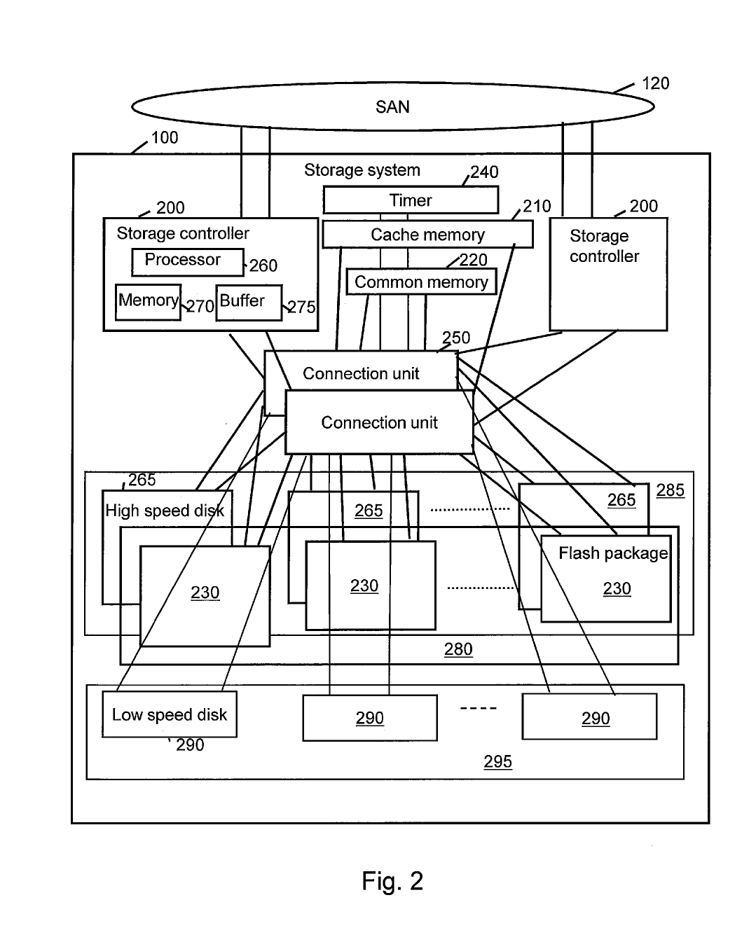

FIG. 2 shows the configuration of the storage system 100.

The storage system 100 comprises one or more storage controllers 200, a cache memory 210, a common memory 220, a timer 240, multiple types (for example, three types) of secondary storages having different performances (for example, one or more flash packages 230, one or more high-speed disks (disk devices with high access speed) 265, and one or more low-speed disks (disk devices with low access speed) 290), and one or more connection units 250 for connecting these components. The timer 240 does not necessarily have to denote the actual time, and may be a counter or the like. The high-speed disk 265, for example, may be a SAS (Serial Attached SCSI (Small Computer System Interface)) HDD (Hard Disk Drive). The low-speed disk 290, for example, may be a SATA (Serial ATA (Advanced Technology Attachment)) HDD.

The flash memory of the flash package 230 includes a number of types. For example, flash memories include SLC (Single Level Cell), which features a high price, high performance and a large number of deletions, and MLC (Multiple Level Cell), which features a low price, low performance, and a small number of deletions. However, both types can be expected to offer faster access speeds that a disk device. The present invention is effective for both the SLC and the MLC. Also, new nonvolatile memories, such as phase-change memory, are likely to make their appearance in the future. The present invention is effective even when a storage comprising such nonvolatile storage media is used as the secondary storage. Hereinbelow, in a case where no distinction is made, a flash package 230, a high-speed disk 265 and a low-speed disk 290 will be called a “storage” (or a secondary storage).

In this example, the present invention is effective even when the storage system comprises storages having different performances (for example, access speeds) either instead of or in addition to at least one flash package 230, high-speed disk 265, or low-speed disk 290. Furthermore, it is supposed that the capacities of the flash package 230, high-speed disk 265, and low-speed disk 290 in this example are all identical for storages having the same performance. However, the present invention is effective even when a storage having a different capacity is mixed in with the multiple storages having identical performance.

The storage controller 200 comprises a memory 270 for storing a program and information, a buffer 275 for temporarily storing data to be inputted/outputted to/from the storage controller 200, and a processor 260, which is connected thereto and processes a read request and a write request issued from the host 110. The buffer 275, for example, is used (1) when creating parity data, as an area for storing information needed to create the parity data and the created parity data, and (2) as a temporary storage area when writing data, which has been stored in a cache area based on a storage, to a storage for storing data permanently.

The connection unit 250 is a mechanism for connecting the respective components inside the storage system 100. Also, in this example, it is supposed that one flash package 230, high-speed disk 265, and low-speed disk 290 are connected to multiple storage controllers 200 using multiple connection units 250 to heighten reliability. However, the present invention is also effective in a case in which one flash package 230, high-speed disk 265, and low-speed disk 290 are only connected to one connection unit 250.

At least one of the cache memory 210 and the common memory 220 are configured from a volatile memory such as DRAM, but may be made nonvolatile by using a battery or the like. These memories 210 and 220 may also be duplexed to heighten reliability. However, the present invention is effective even when the cache memory 210 and the common memory 220 are not made nonvolatile. Data, which is frequently accessed from the storage controller 200 from among the data stored in the flash package 230, the high-speed disk 265, and the low-speed disk 290, may be stored in the cache memory 210. In a case where the storage controller 200 has received a write request from the host 110, the write-target data may be stored in the cache memory 210 and the relevant write request may be completed (write-completion may be notified to the host 110). However, the present invention is effective even for a system in which the write request is completed at the stage where the write-target data has been stored in the storage (the flash package 230, the high-speed disk 265, or the low-speed disk 290). One characteristic feature of this example is the fact that a storage area based on a portion of the flash package 230 (or the high-speed disk 265) is used as the cache area for data stored in the high-speed disk 265 (or low-speed disk 290). The common memory 220 stores control information for the cache memory 210, management information for the storage system 100, inter-storage controller 200 contact information, and synchronization information. In this example, the common memory 220 also stores management information for the flash package 230 and the high-speed disk 265, which constitute the basis of the cache area. Furthermore, the present invention is effective even when these types of management information are stored in the flash package 230 and the high-speed disk 265.

FIG. 23 denotes the configuration of the cache memory 210.

The cache memory 210 is partitioned into fixed-length slots 21100. A slot 21100 constitutes a data storage unit. In this example, it is supposed that the flash package 230, the high-speed disk 265, and the low-speed disk 290 are respectively seen as individual storages from the storage controller 200. Therefore, it is supposed that for higher reliability the storage controller 200 possesses a RAID (Redundant Array of Independent (or Inexpensive) Disks) function, which makes it possible to restore the data of a single storage when this storage fails. In a case where the storage controller 200 has a RAID function, multiple storages of the same type make up one RAID. This will be called a storage group in this example. That is, multiple flash packages 230, multiple high-speed disks 265, and multiple low-speed disks 290 respectively make up RAIDs, and can respectively be called a flash package group 280, a high-speed disk group 285, and a low-speed disk group 295. These groups can collectively be called a storage group. However, the present invention is effective even when the storage controller 200 does not possess such a RAID function.

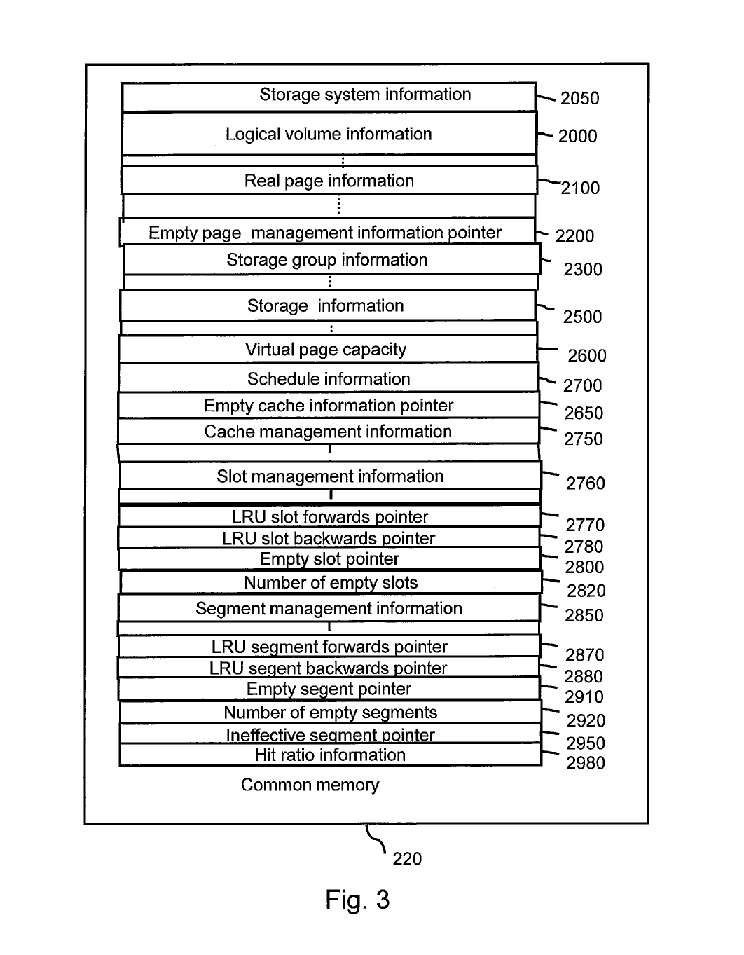

FIG. 3 shows information stored in the common memory 220.

The common memory 220 stores storage system information 2050, logical volume information 2000, real page information 2100, an empty page management information pointer 2200, storage group information 2300, storage information 2500, a virtual page capacity 2600, schedule information 2700, an empty cache information pointer 2650, cache management information 2750, slot management information 2760, a LRU (Least Recently Used) slot forward pointer 2770, a LRU slot backward pointer 2780, an empty slot pointer 2800, the number of empty slots 2820, segment management information 2850, a LRU segment forward pointer 2870, a LRU segment backward pointer 2880, an empty segment pointer 2910, the number of empty segments 2920, an ineffective segment pointer 2950, and hit ratio information 2980. Of these, the storage system information 2050 is information related to the storage system 100, and in Example 1, comprises a storage system identifier. The storage system identifier is the identifier of a relevant storage system 100.

As was explained hereinabove, the storage system 100 comprises a capacity virtualization function. Ordinarily, the storage allocation unit in the capacity virtualization function is called a page. Furthermore, a logical volume is ordinarily a logical storage with respect to which the host 110 performs writing and reading. However, in the present invention, the allocation destination of an area (a page) based on a storage, which is used for caching, is defined as a logical volume (a cache volume). The cache capacity (real capacity) is increased in this cache volume by allocating a page in accordance with the capacity virtualization function. In this example, it is supposed that the logical volume (cache volume) space is partitioned into units called virtual pages, and that an actual storage group is partitioned into units called real pages. The capacity virtualization function can generally make it appear as though the storage capacity of the logical volume is larger than the capacity of the total number of real pages. Generally speaking, one real page is allocated to one virtual page. For this reason, as a rule, the number of virtual pages is larger than the number of real pages. When a real page has not been allocated to the virtual page to which the write-destination address specified in a write request from the host 110 belongs, the storage controller 200 allocates a real page to this virtual page.

The virtual page capacity 2600 is the capacity of a virtual page. However, in this example, the virtual page capacity 2600 is not equivalent to the capacity of a real page. This is because the real page capacity comprises parity data, which differs in accordance with the RAID type. Therefore, the real page capacity is decided in accordance with the RAID type of the storage group to which the real page is allocated. For example, in a case where the data is written in duplicate as in RAID 1, the real page capacity is two times that of the virtual page capacity 2600. In a case where the parity data of the capacity of a single storage is stored in the capacity of N storages as in RAID 5, a capacity of (N+1)/N for the virtual page capacity is ensured. Naturally, in a case where there is no parity data as in RAID 0, the real page capacity is equivalent to the virtual page capacity 2600. Furthermore, in this example, the virtual page capacity 2600 is common throughout the storage system 100, but the present invention is effective even when there is a different virtual page capacity 2600 in the storage system 100. In this example, it is supposed that each storage group is configured using RAID 5. Of course, the present invention is effective even when a storage group is configured using an arbitrary RAID group.

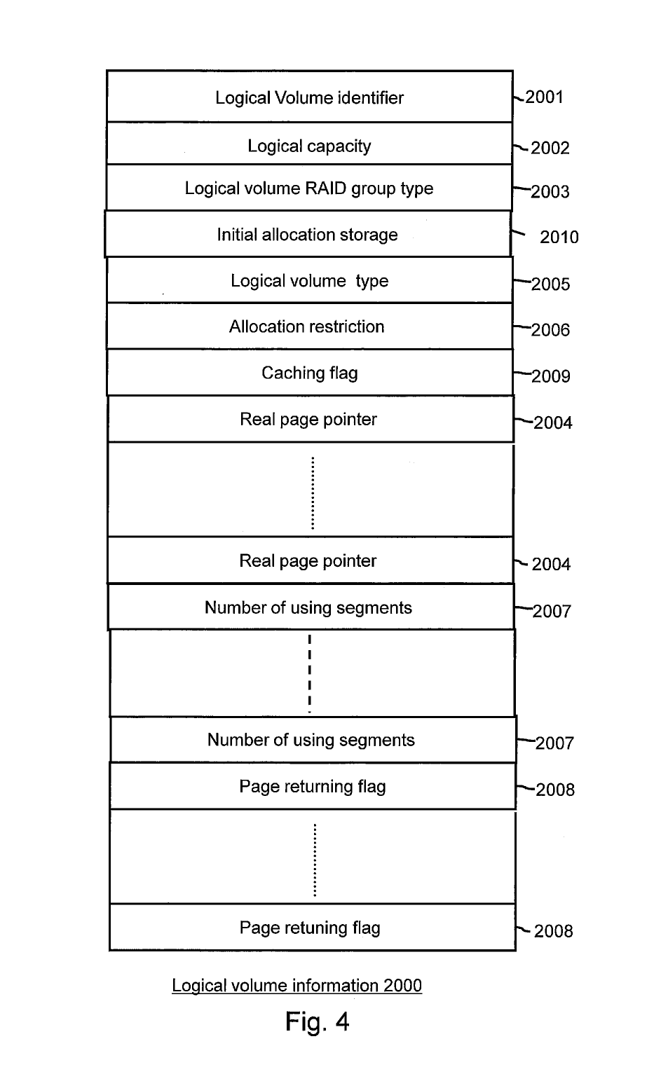

FIG. 4 shows the format of the logical volume information 2000.

A logical volume is a logical storage to/from which data is either written or read by the host 110. Generally speaking, the identifier of a logical volume is unique information inside the storage system 100. Either a read request or a write request issued from the host 110 will comprise a logical volume ID (for example, a LUN (Logical Unit Number)), an address within the logical volume, and the length of either a read-target or a write-target data.

The logical volume information 2000 exists for each logical volume. This information 2000 comprises a logical volume identifier 2001, a logical capacity 2002, a logical volume RAID group type 2003, an initial allocation storage 2010, a logical volume type 2005, an allocation restriction 2006, a caching flag 2009, a real page pointer 2004, the number of using segments 2007, and a page returning flag 2008.

The logical volume identifier 2001 shows the ID of the corresponding logical volume.

The logical capacity 2002 denotes the capacity of this virtual volume.

The logical volume type 2005 denotes the type of the logical volume. In this example, the logical volume type 2005 shows whether the relevant logical volume is a logical volume to/from which the host 110 writes/reads, or a cache volume being used as a cache area.

The logical volume RAID group type 2003 specifies the RAID type of the relevant logical volume, such as RAID 0, RAID 1, and so forth. In a case where the parity data of the capacity of one storage unit is stored in the capacities of N storage units as in RAID 5, it is supposed that the specific numeric value of N will be specified. However, an arbitrary RAID type cannot be specified; the RAID type must be the RAID type of at least one storage group.

The allocation restriction 2006 shows a limit put on storages allocated to the relevant logical volume (for example, information denoting which storage constitutes the basis of the page allocated to the relevant logical volume). Generally speaking, the area (cache volume) used for caching should be an area based on a storage with better performance than the area for storing data (the logical volume from/to which the host reads/writes). Therefore, a real page based on a flash package group 280 may be fixedly allocated to the cache volume, a real page based on either a flash package group 280 or a high-speed disk group 285 may be fixedly allocated to the cache volume, or a real page based on a high-speed disk group 285 may be fixedly allocated to the cache volume. However, the present invention is effective even when a real page based on a low-speed disk group 295 is allocated to the cache volume. In the example that follows, it is supposed that a real page based on a flash package 230 is fixedly allocated to the cache volume. Naturally, the present invention is effective even when a real page based on either a flash package group 280 or a high-speed disk group 285 is fixedly allocated to the cache volume, and when a real page based on a high-speed disk group 285 is fixedly allocated to the cache volume. Alternatively, the allocation restriction 2006 of the logical volume for storing data, which is read/written by the host 110 (hereinafter, host volume), may also be restricted. In this example, it is supposed that an allocation restriction 2006 is specified such that a real page, which is allocated to a cache volume from among multiple real pages based on a flash package group 280, not be allocated to a host volume.

The real page pointer 2004 is a pointer to the real page information 2100 of a real page allocated to a virtual page of the relevant logical volume. The number of real page pointers 2004 is the number of virtual pages in the relevant logical volume (constitutes a number, which is obtained by dividing the logical volume capacity 2002 by the virtual page capacity 2600, +1 in the case of a remainder). The real page corresponding to an initial real page pointer 2004 is the real page allocated to the virtual page at the top of the logical volume, and thereafter, a pointer corresponding to the real page allocated to the next virtual page is stored in the next real page pointer 2004. According to the capacity virtualization function, the allocation of a real page is not triggered by a logical volume being defined, but rather, is triggered by a data write being performed to the relevant virtual page. Therefore, in the case of a virtual page to which a write has yet to be performed, the corresponding real page pointer 2004 is NULL. The respective virtual pages comprising the cache volume are partitioned into segments, which are cache allocation units. The size of a segment is the same as the size of a slot. The number of virtual page segments constitutes a number obtained by dividing the capacity of the virtual page by the capacity of the segment. The number of using segments 2007 and the page returning flag 2008 are information corresponding to a virtual page, but this information is used when the relevant logical volume is utilized as the cache volume. The number of using segments 2007 is the number of data-storing segments among the segments included in the relevant virtual page. The page returning flag 2008 exists in virtual page units. This flag 2008 is only valid in a case where the corresponding virtual page is a virtual page in the cache volume. The page returning flag 2008 is turned ON in a case where it is desirable to end the allocation of a real page to the relevant virtual page when a determination has been made that an adequate hit ratio is obtainable even with a reduced cache capacity. However, since data is stored in the corresponding real page, the corresponding real page cannot be released immediately unless the number of using segments 2007 is 0. In this example, immediately after turning ON the page returning flag 2008, the storage controller 200 may release the relevant virtual page by moving the segment being used by the virtual page corresponding to this flag 2008 to another virtual page (that is, moving the data in the real page allocated to the virtual page corresponding to this flag 2008 to another real page, and, in addition, allocating this other real page to another virtual page). However, in this example, the storage controller 200 refrains from allocating a new segment included in this virtual page, waits for the previously allocated segment to be released, and releases the relevant virtual page.

The caching flag 2009 shows whether data in the relevant logical volume is to be cached to the storage (cache volume).

The initial allocation storage 2010 shows the storage, i.e., the flash package 230, the high-speed disk 265, or the low-speed disk 290, to which caching is to be performed when caching to a storage. As will be explained further below, Example 1 supposes that caching is performed to the flash package 230, and as such, the initial allocation storage 2010 shows the flash package 230.

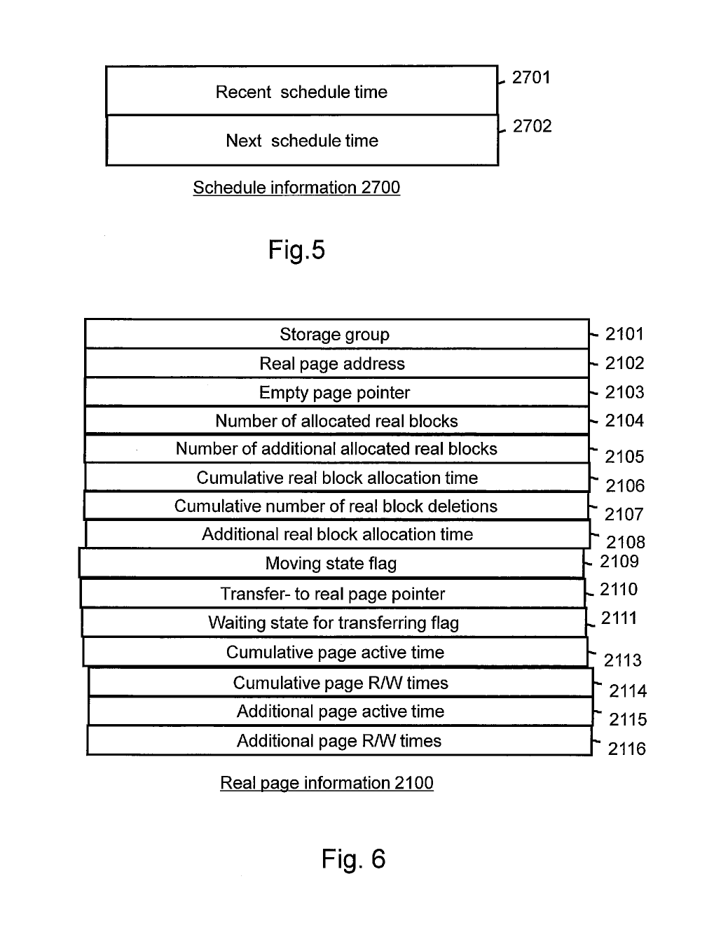

FIG. 5 is the format of the schedule information 2700.

In this example, in a case where the storage controller 200 calculates the utilization rate of a storage group (also the empty capacity and the average life in the case of flash package group 280) and the calculated value does not satisfy a criterion value, which is compared to this value, the storage controller 200 transfers data between real pages, and allocates the transfer-destination virtual page instead of the transfer-source real page to the allocation-destination virtual page of the transfer-source real page. In this example, this processing is started at a specified schedule time. However, the present invention is effective even when the allocation of a real page is changed (when data is transferred between pages) at an arbitrary time.

The schedule information 2700 comprises a recent schedule time 2701 and a next schedule time 2702. The recent schedule time 2701 is the schedule time (past) at which an inter-real page data transfer was most recently executed, and the next schedule time 2702 is the time (future) for scheduling a change in the next inter-real page data transfer. The inter-real page data transfer referred to here, for example, may comprise the carrying out of the following (1) through (3) for each virtual page:

(1) Determining whether or not the access status (for example, the access frequency or the last access time) of a virtual page (in other words, a real page allocated to a virtual page) belongs in an allowable access status range, which corresponds to the storage tier comprising the real page allocated to this virtual page;

(2) in a case where the result of the determination of this (1) is negative, transferring the data in the real page allocated to this virtual page to an unallocated real page in the storage tier corresponding to the allowable access status range to which this virtual page access status belongs; and

(3) allocating the transfer-destination real page to this virtual page instead of the transfer-source real page.

FIG. 6 is the format of the real page information 2100.

The real page information 2100 is management information for a relevant real page, which exists for each real page. The real page information 2100 comprises a storage group 2101, a real page address 2102, an empty page pointer 2103, the number of allocated real blocks 2104, the number of additional allocated real blocks 2105, a cumulative real block allocation time 2106, a cumulative number of real block deletions 2107, an additional real block allocation time 2108, a moving state flag 2109, a transfer to real page pointer 2110, a waiting state for transferring flag 2111, a cumulative page active time 2113, a cumulative page R/W times 2114, an additional page active time 2115, and an additional page R/W times 2116. Furthermore, the number of allocated real blocks 2104, the number of additional allocated real blocks 2105, the cumulative real block allocation time 2106, the cumulative number of real block deletions 2107, and the additional real block allocation time 2108 are information, which become valid (information in which a valid value is set) in a case where the relevant real page is a real page defined in a flash package group 280.

The storage group 2101 shows which storage group the relevant real page is based on. The real page address 2102 is information showing which relative address the relevant real page belongs to within the storage group, which constitutes the basis of the relevant real page. The empty page pointer 2103 becomes a valid value in a case where a real page is not allocated to a virtual page. In accordance with this, this value points to the real page information 2100 corresponding to the next real page, which has not been allocated to a virtual page, within the corresponding storage group. In a case where a virtual page has been allocated, the empty page pointer 2103 becomes a NULL value. The number of allocated real blocks 2104 and the number of additional allocated real blocks 2105 exist in proportion to the number of storages comprising the relevant storage group.

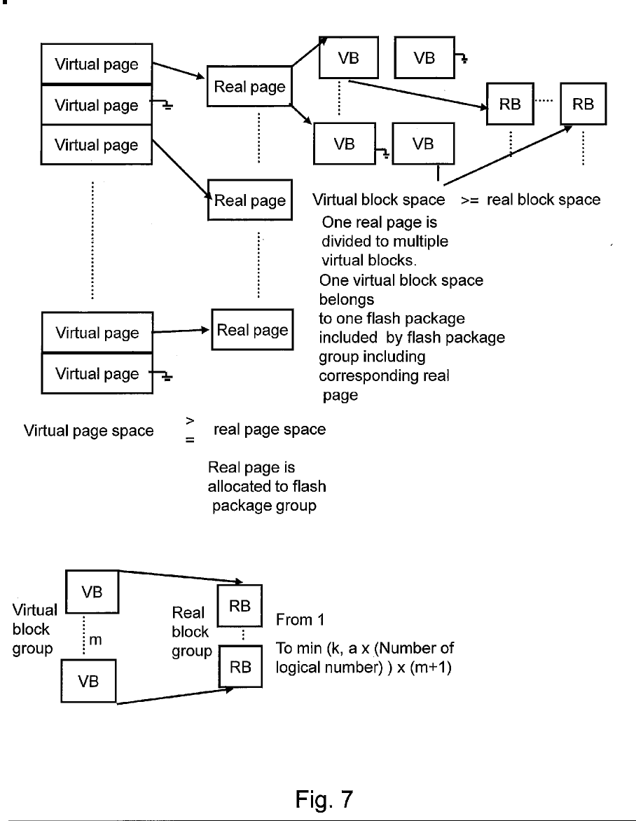

In this example, each flash package 230 has a capacity virtualization function, and appears to the storage controller 200 to be providing capacity in excess of the actual physical capacity. In this example, it is supposed that the unit for capacity virtualization in the flash package 230 is a block, which is the deletion unit of the flash memory. Hereinbelow, a block as seen from the storage controller 200 will be called a virtual block, and a block capable of being allocated to a virtual block will be called a real block. Therefore, in this example, a real page is comprised of virtual blocks. In addition, in this example, a capacity space configured from a virtual block is larger than a capacity space configured from a real block. FIG. 7 shows the relationships among a virtual page, a real page, a virtual block, and a real block. As was already explained, a real page comprises parity data not found in a virtual page. Meanwhile, the data included in a virtual block and a real block is the same. In this example, the flash package 230 appears to the storage controller 200 to have more virtual blocks than the number of real blocks. However, in this example, the storage controller 200 is aware of how many real blocks the flash package 230 actually has, and carries out the reallocation of real pages. In this example, the flash package 230 allocates a real block to a virtual block, which has yet to be allocated with a real block, upon receiving a write request. In a case where a real block has been newly allocated, the flash package 230 notifies the storage controller 200 to this effect. The number of allocated real blocks 2104 is the number of real blocks allocated prior to the recent schedule time 2701 from among the number of real blocks, which has actually been allocated to the relevant real page. Also, the number of additional allocated real blocks 2105 is the number of real blocks allocated subsequent to the recent schedule time 2701 from among the number of real blocks, which has actually been allocated to the relevant real page.

The cumulative real block allocation time 2106, the cumulative number of real block deletions 2107, and the additional real block allocation time 2108 respectively exist in proportion to the number of flash packages 230, which comprise the flash package group 280 constituting the basis of the relevant real page. However, this information is not attribute information of the virtual block included in this real page, but rather is attribute information related to data in this real page. Therefore, in a case where this virtual page is allocated to another real page and data is transferred from the current real page to this other real page, the cumulative real block allocation time 2106, the information of the cumulative number of real block deletions 2107, and the additional real block allocation time 2108 must also be copied from the real page information 2100 of the transfer-source real page to the real page information 2100 of the transfer-destination real page.

The cumulative real block allocation time 2106 totals the elapsed time from the trigger by which the real block was allocated to the respective virtual blocks corresponding to this real block (this allocation trigger is likely to have occurred in a past real page rather than the current real page) until the recent schedule time 2701 for all the virtual blocks. The cumulative number of real block deletions 2107 totals the number of deletions of a virtual block-allocated real block from the trigger by which the real block was allocated to the respective virtual blocks corresponding to this real block for all the virtual blocks. The additional real block allocation time 2108 is the allocation time of a real block allocated to a virtual block subsequent to the recent schedule time 2701. When one real block is newly allocated to the relevant real block, a value obtained by subtracting the time at which the allocation occurred from the next schedule time 2702 is added to the additional real block allocation time 2108. The reason for adding this value will be explained further below.

The moving state flag 2109, the transfer to real page pointer 2110, and the waiting state for transferring flag 2111 are information used when transferring the data of the relevant real page to another real page. The moving state flag 2109 is ON when the data of this real page is in the process of being transferred to the other real page. The transfer to real page pointer 2110 is address information of the transfer-destination real page to which the data of this real page is being transferred. The waiting state for transferring flag 2111 is ON when the decision to transfer the relevant real block has been made.

The cumulative page active time 2113, the cumulative page R/W times 2114, the additional page active time 2115, and the additional page R/W times 2116 are information related to the operation of the corresponding real page. R/W is the abbreviation for read/write (read and write). The cumulative page active time 2113 and the cumulative page R/W times 2114 show the cumulative time of the times when this real page was subjected to R/Ws, and the cumulative number of R/Ws for this real page up until the present. The additional page active time 2115 and the additional page R/W times 2116 of the corresponding real page show the total time of the times when this real page was subjected to R/Ws, and the number of R/Ws for this real page subsequent to the recent schedule time 2701. Using this real page-related information, the storage controller 200 evaluates the degree of congestion of the relevant real page, and when necessary, either transfers the data in the corresponding real page to another real page, which is based on a storage group of the same type, or transfers the data in the corresponding real page to a real page, which is based on a storage group of a different type within the limits of the allocation restriction 2006 (for example, a data transfer from a flash package 230 to a high-speed disk 265).

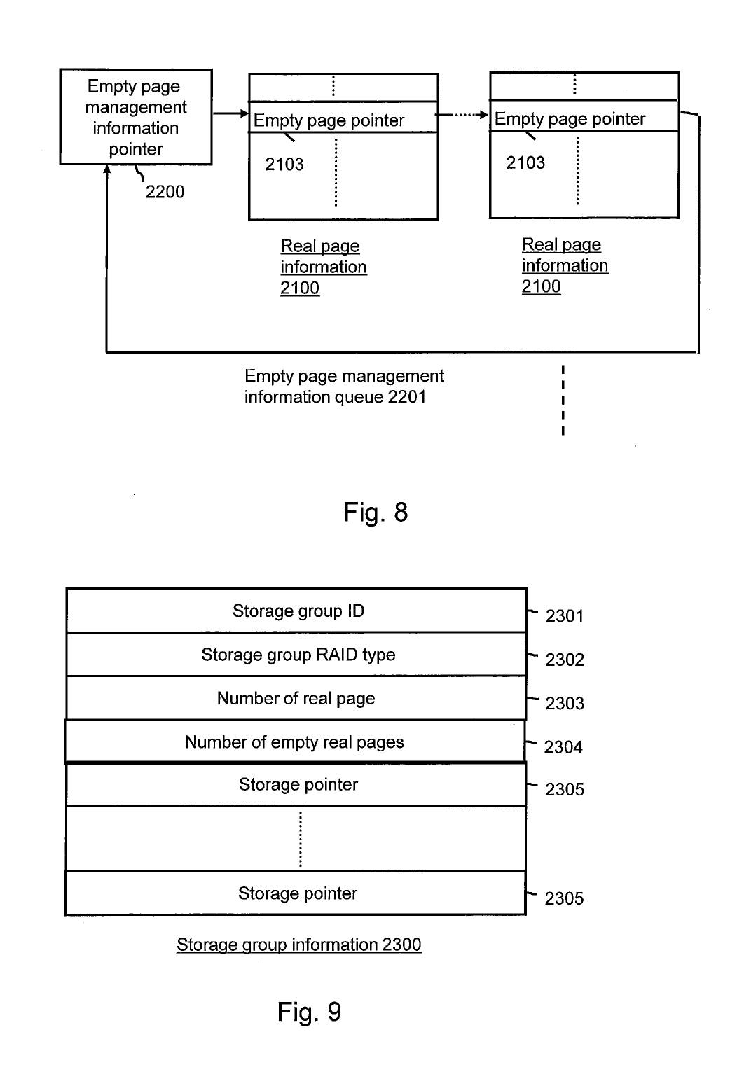

FIG. 8 denotes a set of empty real pages managed in accordance with the empty page management information pointer 2200.

The empty page management information pointer 2200 is information, which is provided for each storage group. Empty page (empty real page) signifies a real page that is not allocated to a virtual page. Also, real page information 2100 corresponding to an empty real page may be called empty real page information 2100. The empty page management information pointer 2200 refers to an address at the top of the empty real page information 2100. Next, the empty page pointer 2103 at the top of the real page information 2100 points to the next empty real page information 2100. In FIG. 8, the empty real page pointer 2103 at the end of the empty real page information 2100 is showing the empty page management information pointer 2200, but may be a NULL value. The storage controller 200, upon receiving a write request having as the write destination a virtual page to which a real page is not allocated, searches for an empty real page based on the empty page management information pointer 2200 corresponding to any storage group, which corresponds to the logical volume RAID group type 2003 and the allocation restriction 2006, for example, the storage group with the highest number of empty real pages among the relevant storage groups, and allocates the empty real page, which was found, to a virtual page.

FIG. 9 shows the format of the storage group information 2300.

The storage group information 2300 comprises a storage group ID 2301, a storage group RAID type 2302, the number of real pages 2303, the number of empty real pages 2304, and a storage pointer 2305.

The storage group ID 2301 is an identifier for a relevant storage group. The storage group RAID type 2302 is the RAID type of the relevant storage group. In this example, the RAID type is the same as was described when explaining the logical volume RAID type 2003. The number of real pages 2303 and the number of empty real pages 2304 respectively show the number of real pages and the number of empty real pages in an entire flash package group 280. The storage pointer 2305 is a pointer to the storage information 2500 of a storage 230, which belongs to the relevant storage group. The number of storage pointers 2305 is the number of storages belonging to the relevant storage group, but this value is determined in accordance with the storage group RAID type 2302.

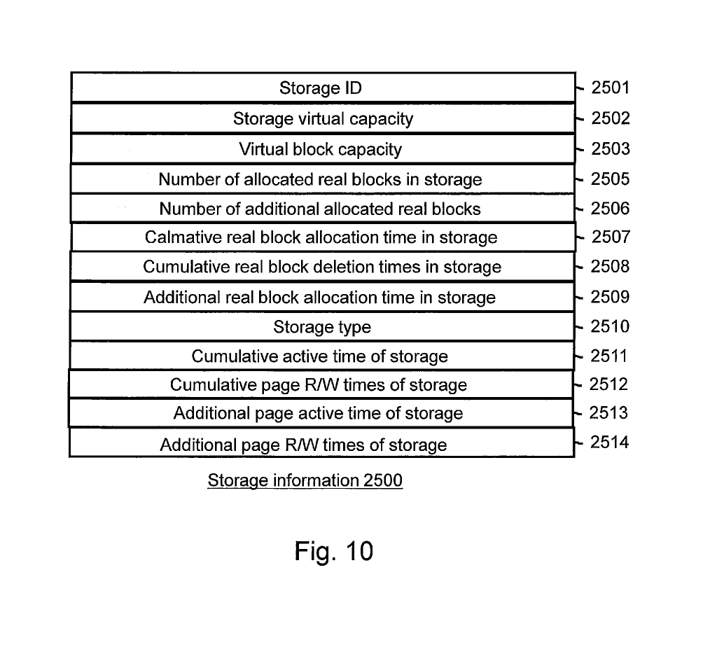

FIG. 10 is the format of the storage information 2500.

The storage information 2500 comprises a storage ID 2501, a storage type 2510, a storage virtual capacity 2502, a virtual block capacity 2503, the number of allocated real blocks in storage 2505, the number of additional allocated real blocks 2506, a cumulative real block allocation time in storage 2507, a cumulative real block deletion times in storage 2508, an additional real block allocation time in storage 2509, a cumulative active time of storage 2511, a cumulative page R/W times of storage 2512, an additional page active time of storage 2513, and an additional page R/W times of storage 2514.

The storage virtual capacity 2502, the virtual block capacity 2503, the number of allocated real blocks in storage 2505, the number of additional allocated real blocks in storage 2506, the cumulative real block allocation time in storage 2507, the cumulative real block deletion times in storage 2508, and the additional real block allocation time in storage 2509 are valid information when the storage is a flash package 230. The cumulative active time of storage 2511 and the cumulative page R/W times of storage 2512 are cumulative values of the operating time and number of R/Ws of the relevant storage. Alternatively, the additional page active time of storage 2513 and the additional page R/W times of storage 2514 are total values of the storage operating time and number of R/Ws subsequent to the recent schedule time of the relevant storage.

The storage ID 2501 is the identifier of the relevant storage. The storage type 2510 shows the type of the relevant storage, for example, a flash package 230, a high-speed disk 265, or a low-speed disk 290. The storage virtual capacity 2502 is the virtual capacity of the relevant storage. The virtual block capacity 2503 is the capacity of the data included in the virtual block and the real block (the data, which is stored in the virtual block, is actually stored in the real block). Therefore, a value obtained by dividing the storage virtual capacity 2502 by the virtual block capacity 2503 constitutes the number of virtual blocks in this storage. The number of allocated real blocks in storage 2505, the number of additional allocated real blocks in storage 2506, the cumulative real block allocation time in storage 2507, the cumulative real block deletion times in storage 2508, and the additional real block allocation time in storage 2509 are the respective totals of the number of allocated real blocks 2104, the number of additional allocated real blocks 2105, the cumulative real block allocation time 2106, the cumulative number of real block deletions 2107, and the additional real block allocation time 2108 in the real page information 2100 related to the relevant storage corresponding to all the real page information 2100 based on the corresponding storage group.

The cache management information 2750 is management information for data stored in a slot 21100 (or a segment), and exists in association with the slot 2100 (or segment).

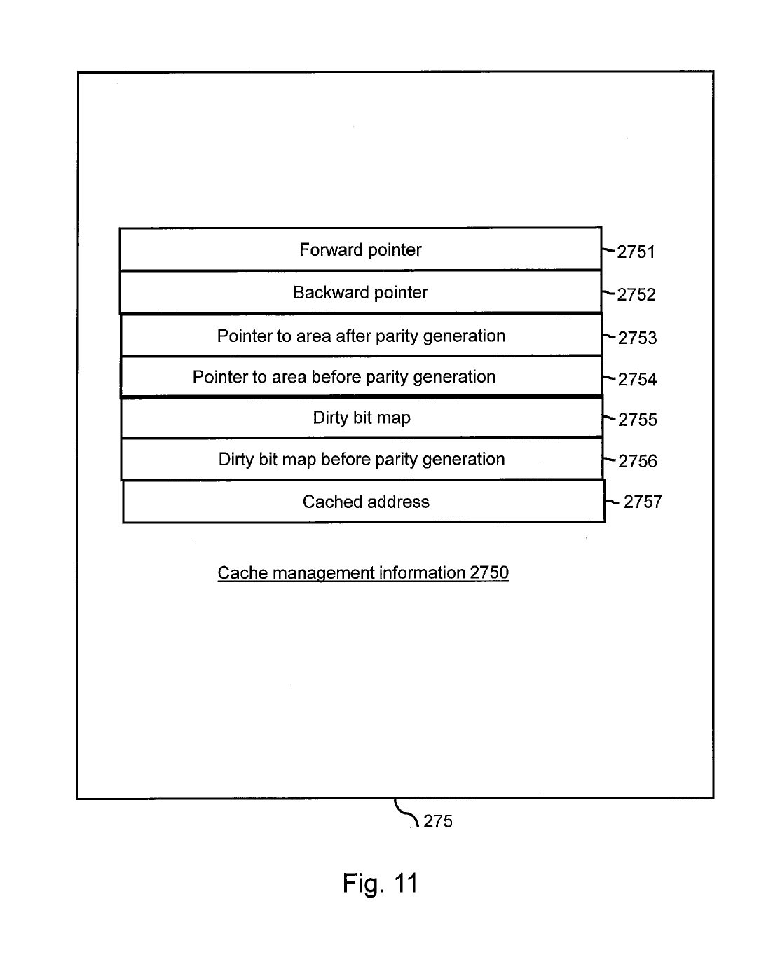

FIG. 11 shows the format of the cache management information 2750.

The cache management information 2750 comprises a forward pointer 2751, a backward pointer 2752, a pointer to area after parity generation 2753, a pointer to area before parity generation 2754, a dirty bitmap 2755, a dirty bitmap before parity generation 2756, and a cached address 2757.

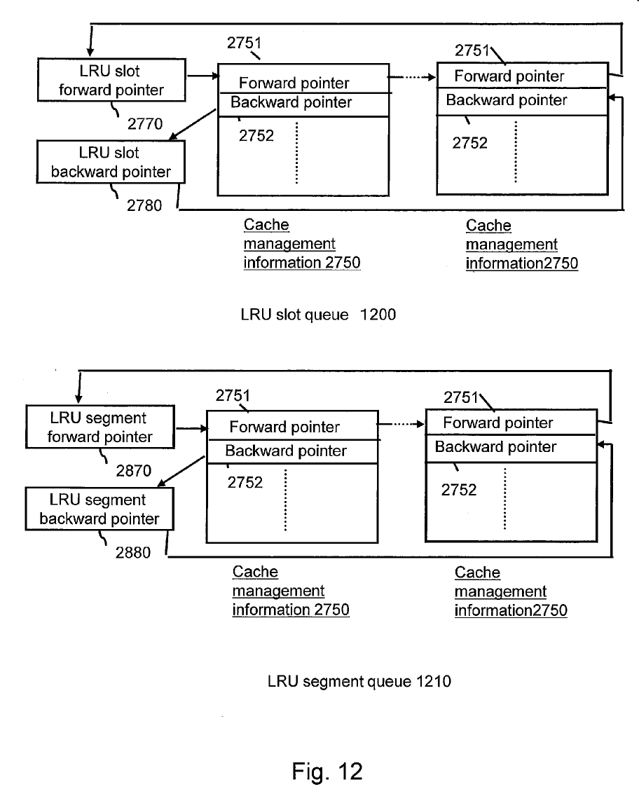

The forward pointer 2751 shows the cache management information 2750 in the forward direction of a LRU slot queue 1200 and a LRU segment queue 1210 shown in FIG. 12. The backward pointer 2752 shows the cache management information 2750 in the backward direction of the LRU slot queue 1200 and LRU segment queue 1210. The pointer to area after parity generation 2753 shows the pointer to a slot 21100 (or segment) in which is stored clean data (data stored in a secondary storage). The pointer to area before parity generation 2754 shows the pointer to a slot 21100 (or segment) in which is stored dirty data for which parity has not been generated. The dirty bitmap before parity generation 2756 shows the dirty data in the slot 21100 (or segment) pointed to by the pointer to area before parity generation 2754. The cached address 2757 shows the logical volume and a relative address thereof for data, which is stored in the slot 21100 (or segment) corresponding to the relevant cache management information 2750.

FIG. 12 denotes the LRU slot queue 1200 and the LRU segment queue 1210.

The LRU slot queue 1200 manages in LRU sequence the cache management information 2750 via which data is stored in a slot. A LRU slot forward pointer 2770 shows recently accessed cache management information 2750. A LRU slot backward pointer 2780 shows the most previously accessed cache management information 2750. In this example, when empty slots 21100 become scarce, data corresponding to the cache management information 2750 indicated by the LRU slot backward pointer 2780 is moved to a segment. The LRU segment queue 1210 manages in LRU sequence the cache management information 2750 via which data is stored in a segment. A LRU forward segment pointer 2870 points to the relevant cache management information 2750 at the time when data, which had been stored in a slot 21100, is moved to a segment. A LRU backward segment pointer 2880 points to the most previously accessed cache management information 2750 in a segment.

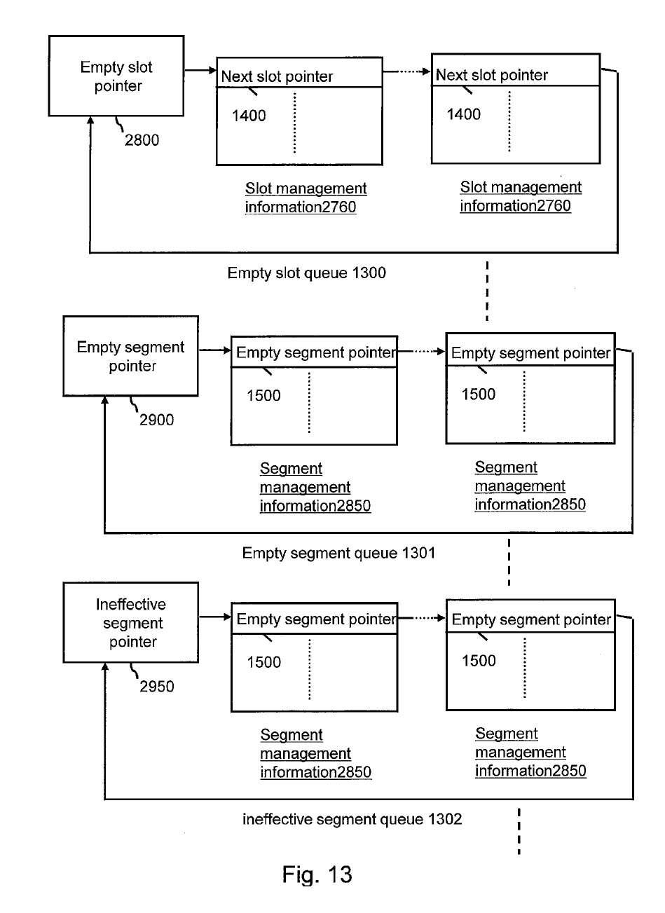

FIG. 13 denotes an empty slot queue 1300, an empty segment queue 1301, and an ineffective segment queue 1302.

The empty slot queue 1300 is a queue for the slot management information 2760 corresponding to a slot 21100 in an empty state.

The empty slot pointer 2800 shows the slot management information 2760 at the top of the empty slot queue 1300. The number of empty slots 2820 is the number of pieces of slot management information 2760 in the empty state.

The empty segment queue 1301 is a queue for the segment management information 2850 corresponding to a segment in the empty state. An empty segment queue 1301 is provided for each type of storage. The type of storage, for example, differs in accordance with the access function of the storage. For example, three empty segment queues 1301 may be respectively provided for the three types of storages, i.e., the flash package 230, the high-speed disk 265, and the low-speed disk 290. However, in this example, since caching is performed for the flash package 230, information associated with the flash package 230 may be valid. However, in a case where a high-speed disk 265 is used for caching, an empty segment queue 1301 corresponding to the high-speed disk 265 is provided. The empty segment pointer 2910 is a pointer to the segment management information 2850 at the top of the empty segment queue 1301. The number of empty segments 2920 is the number of pieces of segment management information 2850 in the empty state.

The ineffective segment queue 1302 is a queue for segment management information 2850 corresponding to a segment, which is not allocated. A page is allocated, the segment management information 2850 at the top of the ineffective segment queue 1302 is obtained for the segment included in this page, and the ineffective segment pointer 2950, which is linked to the ineffective segment queue 1302, is the pointer to the segment management information 2850 at the top of the ineffective segment queue 1302. The ineffective segment queue 1302 may be provided for each type of storage. Therefore, an ineffective segment queue 1302 may be provided for each of three types of storage, i.e., a flash package 230, a high-speed disk 265, and a low-speed disk 290. However, in this example, since caching is performed by the flash package 230, an ineffective segment queue 1302 corresponding to the flash package 230 may be provided.

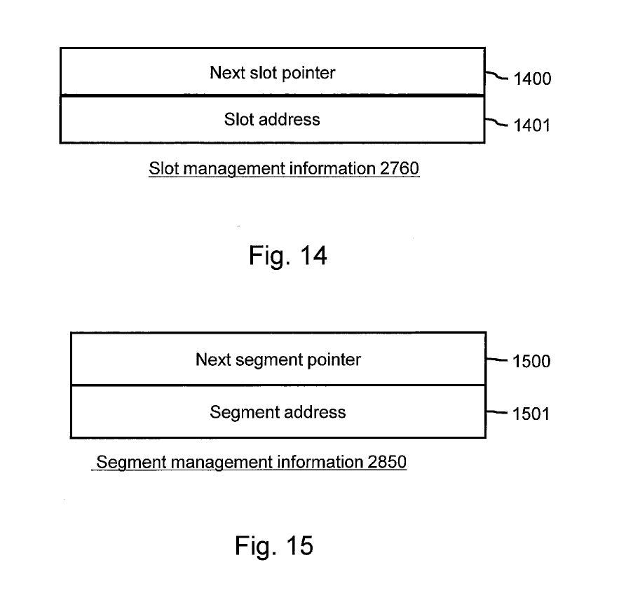

FIG. 14 is the format of the slot management information 2760.

The slot management information 2760 exists for each slot, and comprises a next slot pointer 1400 and a slot address 1401.

The next slot pointer 1400 shows the next slot management information 2760 for a slot, which is in an empty state, when the slot management information 2760 corresponds to an empty slot. The slot address 1401 shows the address of the corresponding slot 21100.

FIG. 15 is the format of the segment management information 2850.

The segment management information 2850 exists for each segment, and comprises a next segment pointer 1500 and segment address 1501.

The next segment pointer 1500 shows the next segment management information 2850 corresponding to a segment, which is in an empty state, when the segment management information 2850 corresponds to an empty segment. The segment address 1501 shows the address of the corresponding segment. This address comprises the ID of the cache volume and the relative address of the relevant logical volume. In accordance with this, the storage controller 200 can get by without changing the segment address 1501 even when transferring the real page allocated to the virtual page comprising this segment.

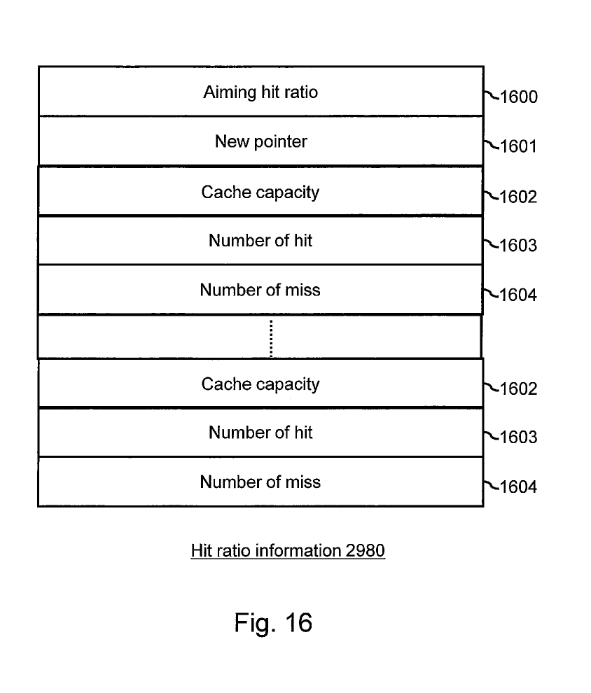

FIG. 16 is the format of the hit ratio information 2980.

The hit ratio information 2980 comprises an aiming hit ratio 1600, a new pointer 1601, a cache capacity 1602, the number of hits 1603, and the number of misses 1604. There is one of each of the aiming hit ratio 1600 and the new pointer 1601, and there are each of the cache capacity 1602, the number of hits 1603, and the number of misses 1604. Essentially, there may be one aiming hit ratio 1600 and one new pointer 1601, and a cache capacity 1602, the number of hits 1603, and the number of misses 1604 may exist for each storage, for example, for a flash package 230, a high-speed disk 265, and a low-speed disk 290. However, in Example 1, because caching is performed in the flash package 230, the information 1602 through 1604, which corresponds to the flash package 230, is valid.

The aiming hit ratio 1600 is a hit ratio targeted at the storage cache. In this example, in a case where the cache hit ratio and the aiming hit ratio 1600 are identical, there is no need to either increase or decrease the cache capacity. In a case where the hit ratio does not reach the aiming hit ratio 1600, the cache capacity is increased. In a case where the hit ratio is clearly higher than the aiming hit ratio 1600 (for example, in a case where the hit ratio is larger than the aiming hit ratio 1600 by equal to or more than a prescribed value), the cache capacity may be decreased. A determination regarding controlling the cache capacity may be made at a schedule time (e.g. the schedule time is represented by the schedule information 2700). The cache capacity required to achieve the aiming hit ratio 1600 may be predicted based on the cache capacities 1602 and hit ratios (number of hits 1603/(number of hits 1603+number of misses 1604)) of the past m schedule times. Real pages are either obtained or released to bring the cache capacity closer (preferably identical) to the predicted capacity.

Next, the operations executed by the storage controller 200 will be explained using the management information explained hereinabove. First, the operation of the storage controller 200 will be explained. The operation of the storage controller 200 is executed by a processor 260 inside the storage controller 200, and the programs therefor are stored in a memory 270.

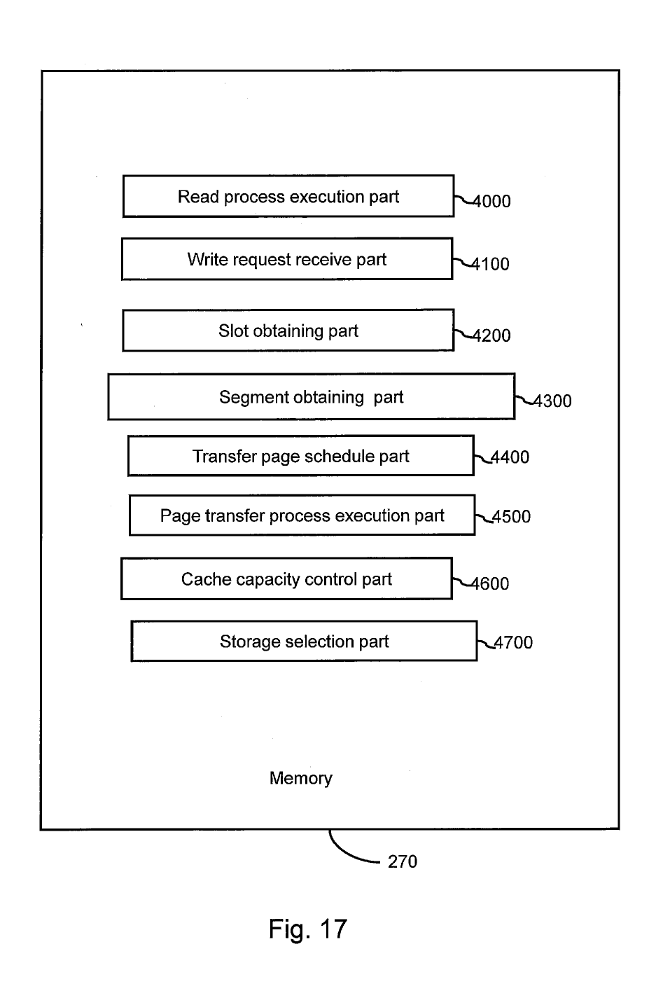

FIG. 17 shows the programs inside the memory 270.

The programs related to this example are a read process execution part 4000, a write request receive part 4100, a slot obtaining part 4200, a segment obtaining part 4300, a transfer page schedule part 4400, a page transfer process execution part 4500, a storage selection part 4700, and a cache capacity control part 4600. These programs realize higher-level (for example, for multiple flash packages 230) wear leveling technology and capacity virtualization technology. These programs are executed by the processor 260. Either a program or the processor 260 may be given as the doer of the processing, which is executed by the processor 260.

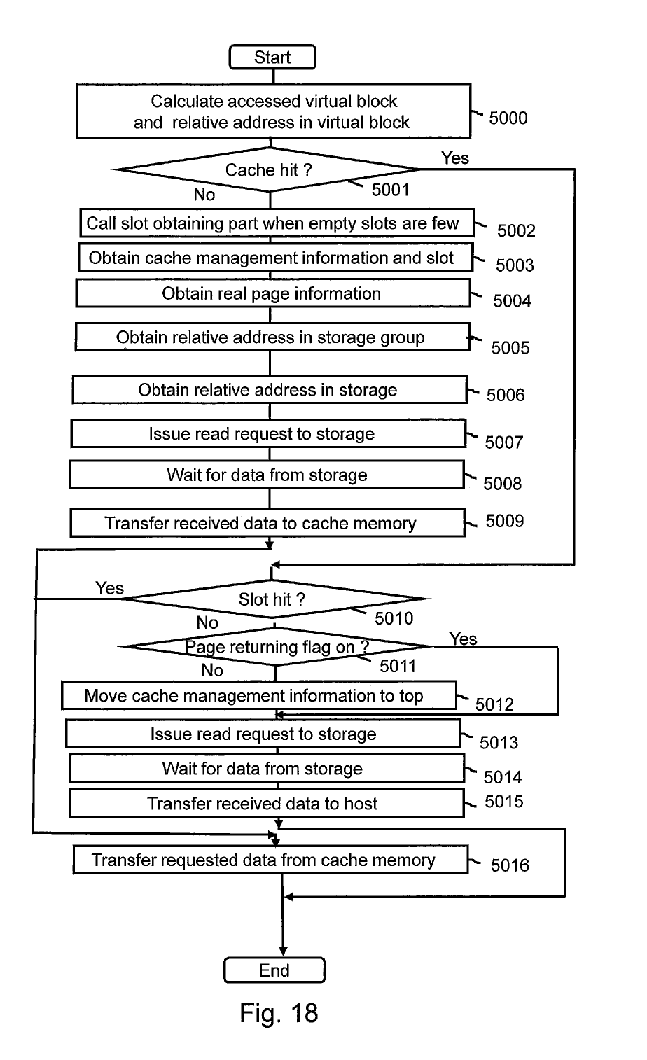

FIG. 18 is the flow of processing of the read process execution part 4000. The read process execution part 4000 is executed when the storage controller 200 has received a read request from the host 110.

Step 5000: The processor 260 calculates the corresponding virtual page (read-source virtual page) and a relative address in this virtual page based on the read-target address specified in the received read request.

Step 5001: The processor 260 checks whether there was a hit for the data (whether the data exists), which constitutes the read target, in a slot 21100 or a segment. In the case of a hit, the processor 260 jumps to Step 5010.

Step 5002: In the case of a miss, the processor 260 checks the number of empty slots 2820. In a case where the number of empty slots 2820 is less than a fixed value, the processor 260 calls the slot obtaining part 4200. In a case where the number of empty slots 2820 is equal to or larger than the fixed value, the processor 260 moves to Step 5003.

Step 5003: The processor 260 obtains the cache management information 2750 from the empty cache management information queue for storing a slot's worth of data comprising the read-target data, and stores the relative address and ID of the read-target logical volume in the cached address 2757 in this information 2750. The processor 260 also increments by one the number of misses 1640 corresponding to this point in time (the schedule point in time). In addition, the processor 260 operates the forward pointer 2751 and the backward pointer 2752 in the above-mentioned obtained information 2750, and sets the relevant cache management information 2750 at the top of the LRU slot queue 1200. The processor 260 also obtains the slot management information 2760 from the empty slot management information queue 1300, and sets the address of the slot management information 2760 in the cache management information 2750. Furthermore, the empty cache management queue is a queue for the cache management information 2750 corresponding to a slot 21100 (or a segment) in an empty state. The empty cache management information pointer shows the cache management information 2750 at the top of the empty cache management information queue.

Step 5004: At this point, the processor 260 must load the slot's worth of data comprising the read-target data into a slot 21100. In the relevant step, the processor 260 first obtains the real page information 2100 corresponding to the real page allocated to the virtual page constituting the read target from the real page pointer 2004 of the logical volume information 2000.

Step 5005: The processor 260 obtains the storage group to which the relevant real page belongs and the top address of the relevant real page storage group from the storage group 2101 and the real page address 2102 of the obtained real page information 2100.

Step 5006: The processor 260 calculates a relative address in the real page constituting the access target of the relevant request based on the relative address in the virtual page obtained in Step 5005 and the RAID type 2302 in the storage group. The processor 260 obtains the storage address, which will be the access target, based on the calculated real page relative address, the storage group RAID type 2302, and the storage pointer 2305.

Step 5007: The processor 260 issues the read request specifying the obtained address to the storage obtained in Step 5006.

Step 5008: The processor 260 waits for the data to be sent from the storage 230.

Step 5009: The processor 260 stores the data sent from the storage in a slot 21100.

Thereafter, the processor 260 jumps to Step 5016.

Step 5010: At this point, the processor 260 checks whether there was a hit for the requested data in a slot 21100. In the case of a hit, the processor 260 jumps to Step 5016.

Step 5011: In a case where the requested data (the read-target data) is stored in a segment rather than a slot, there is a method whereby the data of the segment in the relevant cache management information 2750 is moved one time to a slot 21100 (the DRAM cache). Naturally, adopting such a method is valid in the present invention. The processor 260 also increments the number of hits 1603 by one. However, in this example, the processor 260 decides to move the cache management information corresponding to the relevant segment to the top of the LRU segment queue 1210. In this step, the processor 260 first checks whether the page returning flag 2008 of the virtual page comprising this segment is ON. When this flag 2008 is ON, the processor 260 jumps to Step 5013 without performing a queue transfer.

Step 5012: The processor 260 transfers the relevant cache management information 2750 to the top of the LRU segment queue.

Step 5013: The processor 260 issues a read request to the storage to read the requested data stored in the cache area from the storage to the buffer 275.

Step 5014: The processor 260 waits for the data to be sent from the storage 230 to the buffer 275.

Step 5015: The processor 260 sends the data, which was sent from the storage and stored in the buffer 275, to the host 110.

Step 5016: The processor 260 sends the data specified in the relevant read request from the slot 21100 to the host 110.

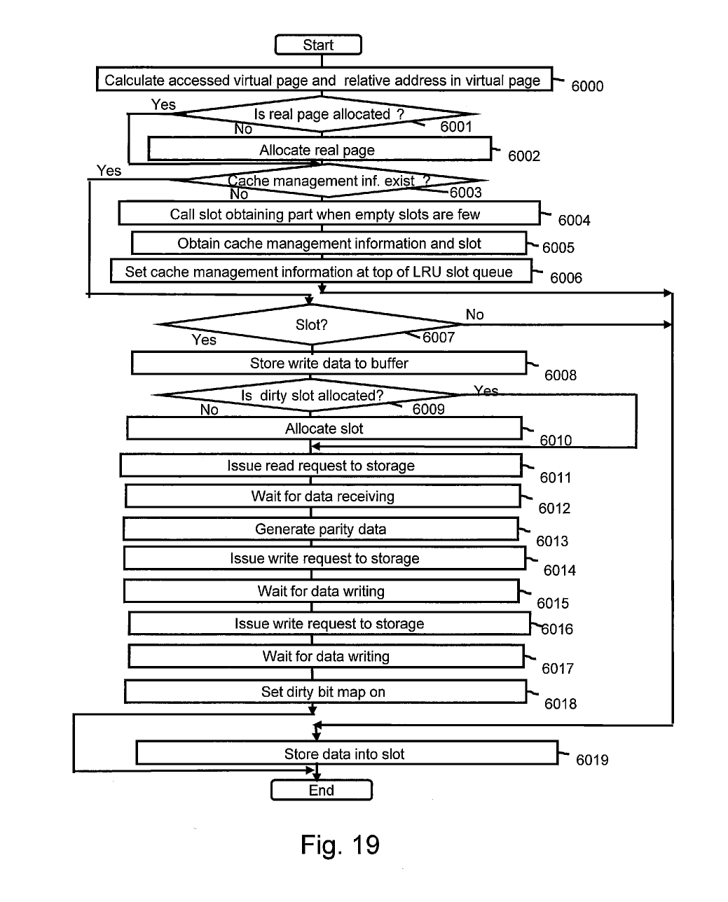

FIG. 19 is the flow of processing of the write request receive part 4100. The write request receive part 4100 is executed when the storage controller 200 has received a write request from the host 110.

Step 6000: The processor 260 calculates the corresponding virtual page (the write target virtual page) and a relative address in this virtual page based on the write-target address of the received write request.

Step 6001: The processor 260 references the real page pointer 2004 in the logical volume information 2000 corresponding to the logical volume ID specified in the write request, and checks whether a real page is allocated to the virtual page obtained in Step 6000. In a case where a real page has been allocated, the processor 260 jumps to Step 6003.

Step 6002: In this step, the processor 260 allocates a real page to the corresponding virtual page. The processor 260 references the RAID type 2002 and the allocation restriction 2006 of the logical volume information 2000, the storage group RAID type 2303 and the number of empty real pages 2304, and decides which storage group real page to allocate. Thereafter, the processor 260 references the empty page management information pointer 2200 of the corresponding storage group and sets the relevant real page pointer 2004 to indicate the top empty page information 2100. The processor 260 thus allocates a real page to the virtual page. Furthermore, the processor 260 sets the empty page management information pointer 2200 to indicate the next real page information 2100 (the real page information 2100 indicated by the empty page pointer 2103 in the real page information 2100 of the real page allocated to the virtual page), and also sets the empty page pointer 2103 in the real page information 2100 of the real page allocated to the virtual page to NULL. The processor 260 reduces the number of the number of empty pages 2304 of the flash package group management information corresponding to the relevant real page. In this example, the processing for allocating a virtual page to a real page is performed when the write request is received, but in the present invention, this allocation process may be executed up until the data is stored in the flash package 230.

Step 6003: The processor 260 checks whether cache management information 2750 is allocated to the slot 21100 comprising the write-target data. In a case where the cache management information 2750 has been allocated, the processor 260 jumps to Step 6007.

Step 6004: In a case where the cache management information 2750 has not been allocated, the processor 260 checks the number of empty slots 2820. In a case where the number of empty slots 2820 is less than a prescribed value, the processor 260 calls the slot obtaining part 4200. In a case where the number of empty slots 2820 is equal to or larger than the prescribed value, the processor 260 moves to Step 6005.

Step 6005: The processor 260 obtains the cache management information 2750 from the empty cache management information queue for storing the slot's worth of data comprising the write-target data, and stores the logical volume and relative address regarded as the read target in a cached address 2757 in this information 2750.

Step 6006: The processor 260 sets the obtained cache management information 2750 in the top location of the LRU slot queue 1200.

Step 6007: The processor 260 determines whether the area obtained using the relevant cache management information 2750 is a slot 21100 (cache memory 210) or a segment (storage). In a case where this obtained area is a segment, the processor 260 jumps to Step 6019.

Step 6008: This step is executed in a case where the write data is cached in the storage. In this example, the processor 260 writes the write data to the storage (a storage-based real page allocated to the cache volume), and completes the write request. The present invention is effective even when the write request is completed at the stage when the write data is written to the cache memory 210. The processor 260 stores the write data received from the host 110 in the buffer 275 at this point.

Step 6009: At this point, the processor 260 checks whether the pointer to area before parity generation 2754 of the cache management information 2750 is valid (checks whether the slot 21100 has been obtained). Thereafter, the processor 260 jumps to Step 6011.

Step 6010: The processor 260 obtains slot management information 2760 from the empty slot queue 1300 for storing the write data, and sets the address of this slot management information 2760 in the pointer to area before parity generation 2754.

Step 6011: The processor 260, based on the pointer to area before parity generation 2754, references the corresponding segment management information 2850 and recognizes the area of the parity data. The processor 260 issues a read request to the storage for storing the information required for generating the parity data in the buffer 275.

Step 6012: The processor 260 waits for the necessary data to be read to the buffer 275.

Step 6013: The processor 260 generates new parity data in the buffer 275.

Step 6014: The processor 260 issues a write request to the storage for writing the generated parity data to the storage.

Step 6015: The processor 260 waits for the write to be completed.

Step 6016: The processor 260 issues a write request to the storage for writing the segment management information indicated by the pointer to area before parity generation 2754 to the corresponding segment.

Step 6017: The processor 260 waits for the write to be completed.

Step 6018: At this point, the processor 260 operates the forward pointer 2751 and the backward pointer 2752 and sets the relevant cache management information 2750 at the top of the LRU slot queue 1200. In addition, the processor 260 turns ON the corresponding dirty bit map before parity generation 2756. The processor 260 transfers the write data from the buffer 275 to the slot 21100.

Step 6019: At this point, the processor 260 operates the forward pointer 2751 and the backward pointer 2752 and sets the relevant cache management information 2750 in the LRU slot queue 1200. In addition, the processor 260 turns ON the corresponding dirty bit map before parity generation 2756, receives the write data from the host 110, and stores this write data in the slot 21100.

Since the storage group adopts a RAID configuration, parity data must be generated with respect to the write data stored on the cache memory 210. This is required when data is written to both the cache volume and the host volume. The area for storing the parity data is also included in the real page, and as such, the storage address in the real page for the parity data corresponding to the write data is uniquely stipulated as well. In this example, the processor 260 stores data, which is needed to generate the parity data but is not in the cache memory 210, and the generated parity data in the buffer 275. The processor 260 attaches to the parity data on the buffer 275 information showing which address in which storage the parity data should be written the same as for the write data. In this example, the processor 260 divides writes to storage into two broad categories. That is, (A) a data write to the cache volume, and (B) a data write to the host volume. (A) is a portion of the processing of the slot obtaining part 4200, which is executed when the number of empty slots 2820 has decreased, and (B) is a portion of the processing of the segment obtaining part 4300 executed when the number of empty segments 2920 has decreased.

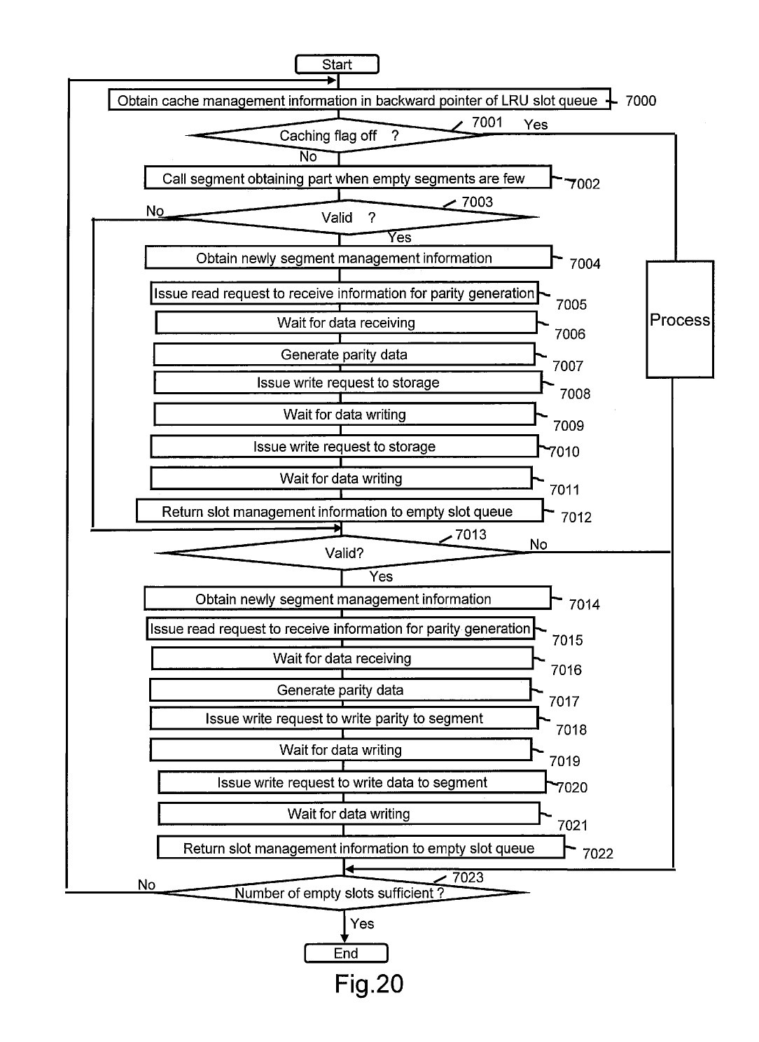

FIG. 20 is the flow of processing of the slot obtaining part 4200. The slot obtaining part 4200 is executed by the processor 260 as needed. In a case where the number of empty slots 2820 is equal to or smaller than a fixed value during processing, which is carried out when either a read request or a write request has been received from the host 110, the slot obtaining part 4200 is called to increase the number of empty slots 2820.

Step 7000: The processor 260 removes the cache management information 2750 indicated by the LRU slot backward pointer 2780 of the LRU slot queue 1200 from the LRU slot queue 1200. Since caching is performed to the storage shown in the initial allocation storage 2010, the processor 260 recognizes the empty segment queue 1301 corresponding to this storage. However, in Example 1, since the caching-destination storage is a flash package 230, the empty segment queue 1301 corresponding thereto is recognized.

Step 7001: At this point, the processor 260 checks the cached address 2757 of the fetched cache management information 2750, and recognizes the logical volume corresponding to the relevant slot. In addition, the processor 260 checks whether the caching flag 2009 of the relevant logical volume is ON. Since storage caching is not performed in a case where the flag 2009 is OFF, the processer 260 performs a prescribed process. This process may be a known process. For this reason, an explanation thereof will be omitted. The processing in a case where the caching flag 2009 is ON will be explained hereinbelow.

Step 7002: The processor 260 checks the number of empty segments 2920. In a case where the number of empty segments 2920 is equal to or smaller than a prescribed value, the processor 260 calls the segment obtaining part 4300.

Step 7003: The processor 260 checks the pointer to area after parity generation 2753. In a case where this pointer 2753 is invalid, the processor 260 jumps to Step 7013. In this example, the slot 21100 indicated by the pointer to area after parity generation 2753 is in a clean state, and is being cached in the storage. However, the present invention is effective even when clean data, which has not been updated, is not cached in the storage.

Step 7004: The processor 260 fetches the segment address 1501 of the segment management information 2850 from the empty segment queue 1301, and recognizes the segment (the logical volume and relative address) corresponding to this segment management information 2850. At this time, the processor 260 decreases the number of empty segments 2920. In addition, the processor 260 recognizes the area in which the parity data of this segment is stored.

Step 7005: At this point, the processor 260 issues a read request to the storage for storing the information required for generating the parity data in the buffer 275.

Step 7006: The processor 260 waits for the needed data to be read to the buffer 275.

Step 7007: The processor generates new parity data in the buffer 275.

Step 7008: The processor 260 issues a write request to the storage for writing the generated parity data to the storage.

Step 7009: The processor 260 waits for the write to be completed.

Step 7010: The processor 260 issues a write request to the storage for writing the data stored in the slot 21100 indicated by the pointer to area after parity generation 2753 to the segment recognized in Step 7003.

Step 7011: The processor 260 waits for the write to be completed.

Step 7012: The processor 260 increases the number of empty slots 2820 by linking the slot management information 2760 indicated by the pointer to area after parity generation 2753 to the empty slot queue 1300. In addition, the processor 260 sets the pointer to area after parity generation 2753 to indicate the segment management information 2850 recognized in Step 7003.

Step 7013: The processor 260 checks the pointer to area before parity generation 2754. In a case where this pointer 2754 is invalid, the processor 260 jumps to Step 7023.

Step 7014: The processor 260 fetches the segment address 1501 of the segment management information 2850 from the empty segment queue 1301, and recognizes the segment (the logical volume and relative address) corresponding to this segment management information 2850. At this time, the processor 260 decreases the number of empty segments 2920. In addition, the processor 260 recognizes the area in which the parity data of this segment is stored.

Step 7015: At this point, the processor 260 issues a read request to the storage for storing the information required for generating the parity data in the buffer 275.

Step 7016: The processor 260 waits for the needed data to be read to the buffer 275.

Step 7017: The processor 260 generates new parity data in the buffer 275.

Step 7018: The processor 260 issues a write request to the storage for writing the generated parity data to the storage.

Step 7019: The processor 260 waits for the write to be completed.

Step 7020: The processor 260 issues a write request to the storage for writing the data stored in the slot 21100 indicated by the pointer to area before parity generation 2754 to the segment recognized in Step 7003.

Step 7021: The processor 260 waits for the write to be completed.

Step 7022: The processor 260 increases the number of empty slots 2820 by linking the slot management information 2760 indicated by the pointer to area before parity generation 2754 to the empty slot queue 1300. In addition, the processor 260 sets the pointer to area before parity generation 2754 to indicate the segment management information 2850 recognized in Step 7003.

Step 7023: The processor 260 checks the number of empty slots 2820. In a case where this number 2820 is larger than a prescribed value, the processor 260 ends the processing. Otherwise, the processor 260 jumps to Step 7000.

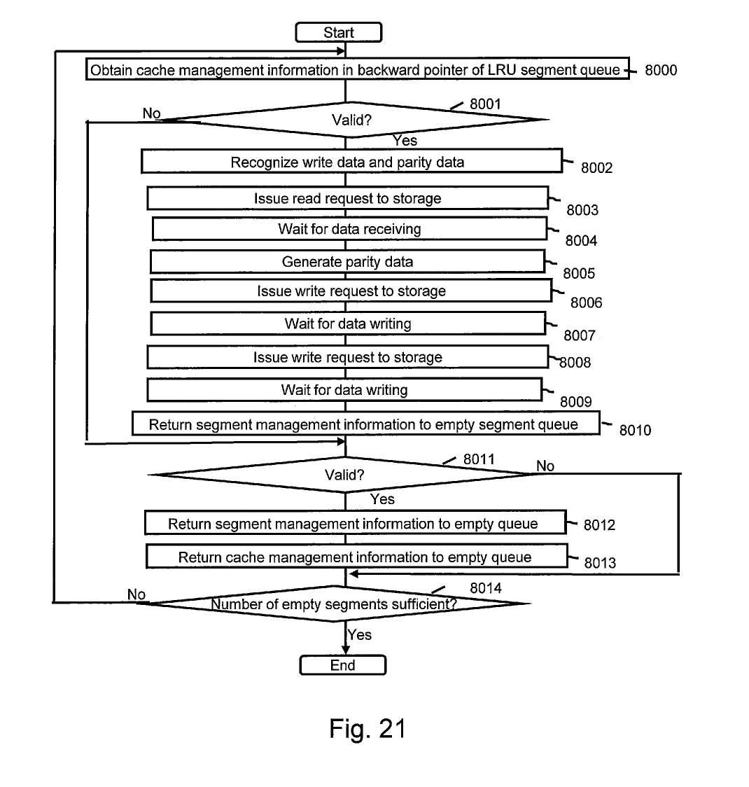

FIG. 21 is the flow of processing of the segment obtaining 4300. The segment obtaining part 4300 is executed by the processor 260 as needed. In a case where the number of empty segments 2920 is equal to or smaller than a fixed value during processing, which is carried out when either a read request or a write request has been received from the host 110, the segment obtaining part 4300 is called to increase the number of empty segments 2920.

Step 8000: The processor 260 removes the segment management information 2850 indicated by the LRU segment backward pointer 2880 of the LRU segment queue 1210 from the LRU segment queue 1210.

Step 8001: The processor 260 checks the pointer to area before parity generation 2754. In a case where this pointer 2754 is invalid, the processor 260 jumps to Step 8011.

Step 8002: The processor 260 fetches the segment address 1501 of the corresponding segment management information 2850, and recognizes the segment (the logical volume and relative address) corresponding to this segment management information 2850. The processor 260 also recognizes the area in which the parity data of this segment is stored. The processor 260 recognizes the storage and the address to which data is to be written for writing the data indicated by the dirty bit map before parity generation 2756. In addition, the processor 260 recognizes storage and address of the corresponding parity.

Step 8003: At this point, the processor 260 issues a read request to the storage for storing the information required for generating the parity data in the buffer 275.

Step 8004: The processor 260 waits for the needed data to be read to the buffer 275.

Step 8005: The processor 260 generates new parity data in the buffer 275.

Step 8006: The processor 260 issues a write request to the storage for writing the generated parity data to the storage.

Step 8007: The processor 260 waits for the write to be completed.

Step 8008: The processor 260 requests that the data recognized in Step 8002 be written to the recognized address in the storage recognized in the same step.

Step 8009: The processor 260 waits for the write to be completed.

Step 8010: The processor 260 checks whether the page returning flag 2008 corresponding to the virtual page comprising the relevant segment is ON. In a case where this flag 2008 is OFF, the processor 260 returns the segment management information 2850 indicated by the pointer to area before parity generation 2754 to the empty segment queue 1301, and increases the number of empty segments 2920. In a case where this flag 2008 is ON, the processor 260 transfers the relevant segment management information 2850 to the ineffective segment queue 1302, subtracts one from the number of using segments 2007, and when this number of using segments 2007 reaches 0, the processor 260 releases the real page allocated to the corresponding virtual page. The processor 260 also sets the pointer to area before parity generation 2754 to NULL in every case.

Step 8011: At this point, the processor 260 checks whether the pointer to area after parity generation 2753 is valid. In a case where this pointer 2753 is invalid, the processor 260 jumps to Step 8014.

Step 8012: The processor 260 checks whether the page returning flag corresponding to the virtual page comprising the relevant segment is ON. In a case where this flag is OFF, the processor 260 returns the segment management information 2850 indicated by the pointer to area after parity generation 2702 to the empty segment queue 1320, and increases the number of empty segments 2920. In a case where this flag is ON, the processor 260 transfers the relevant segment management information 2850 to the ineffective segment queue 1302, subtracts one from the number of using segments 2007, and when this number of using segments 2007 reaches 0, releases the real page allocated to the corresponding virtual page. The processor 260 also sets the pointer to area after parity generation 2753 to NULL in every case.

Step 8013: At this point, the processor 260 returns the cache management information 2750 to the empty cache management information queue.

Step 8014: At this point, the processor 260 checks whether the number of empty segments 2920 is equal to or larger than a prescribed value. In a case where the number 2920 is not equal to or larger than the prescribed value, the processor 260 returns to Step 8000. In a case where the number 2920 is equal to or larger than the prescribed value, the processor 260 ends the processing.

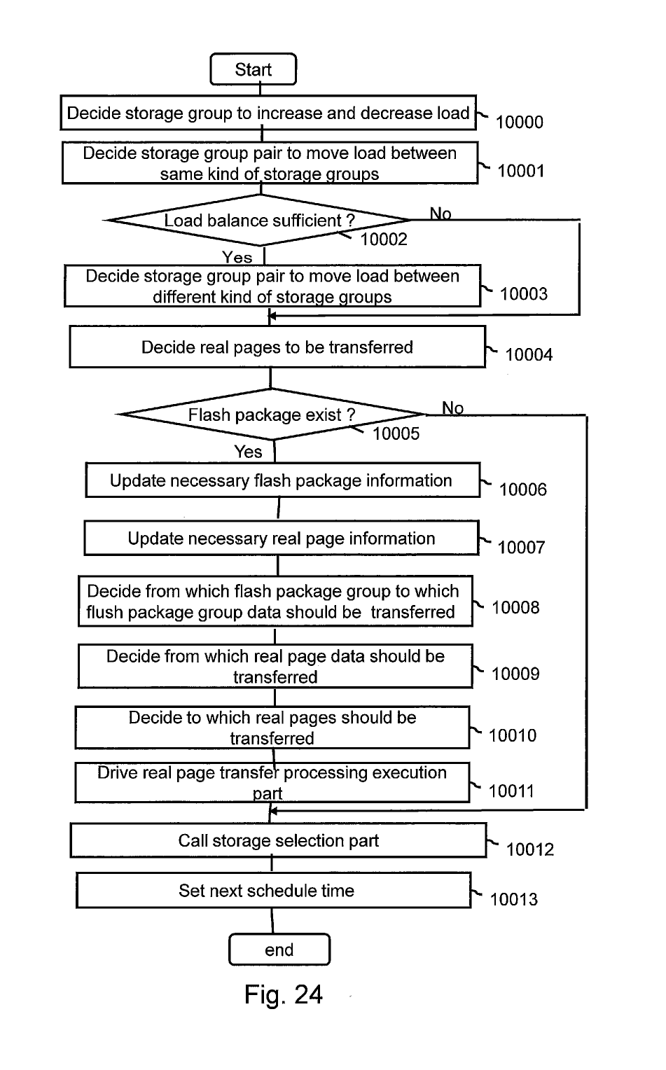

FIG. 24 is the flow of processing of the transfer page schedule part 4400. The transfer page schedule part 4400 starts execution when a timer 240 reaches the next schedule time 2702. The transfer page schedule part 4400 transfers data in a real page between storage groups in order to maintain balanced performance between storage groups. In this example, the allocation of real pages for achieving tight performance throughout the storage system 100 is made possible in accordance with the storage controller 200 controlling both a real page, which is allocated as a cache area, and a real page, which is allocated to a host volume. Furthermore, it is preferable that the real page allocated as a cache area feature better access performance (a faster access speed) than the real page allocated to the host volume. Therefore, in this example, the real page allocated as the cache area may be a real page based on a flash package group 280, and the real page allocated to the host volume may be a real page based on either a high-speed disk group 285 or a low-speed disk group 295. Also, with regard to the flash package group 280, page allocation can be performed by taking into account the number of block deletions rather than performance alone. In this example, the storage controller 200 has a capacity virtualization function, and can also realize page allocation so as to balance the number of empty blocks between flash packages.

Step 10000: The processor 260 calculates a virtual availability factor by dividing the cumulative active time of storage 2511 of all the storages by (the next schedule time 2702−the recent schedule time 2701). The processor 260 decides to transfer the data in the real page from the storage group comprising a storage for which this value is equal to or larger than a fixed value A, and to decrease the load. In addition, the processor 260 calculates how much to decrease the virtual availability factor. The processor 260 also decides to use a storage group for which the maximum value of the virtual availability factor is equal to or less than a fixed value B as the group, which serves as the basis of the transfer-destination real page, and how much the virtual availability factor may be increased.

Step 10001: First, the processor 260 decides a pair of storage groups, which will constitute the transfer source and the transfer destination between the same type of storage groups. In accordance with this, the processor 260 decides how much virtual availability factor to respectively transfer between the pair of storage groups constituting the transfer source and the transfer destination. In accordance with this, the virtual availability factors of the transfer source and the transfer destination become one-to-one.

Step 10002: The processor 260, in a case where the transfer destination falls within the allowable range even when the entire virtual availability factor of the transfer source is added to the transfer-destination storage group, jumps to Step 10004.

Step 10003: The processor 260 decides on a pair of storage groups as the transfer source and transfer destination between different types of storage groups. In accordance with this, since the virtual availability factor differs for the transfer source and the transfer destination, normalization is performed. The processor 260 decides on a pair of storage groups as the transfer source and the transfer destination between different storage groups, a normalized virtual availability factor, which will decrease for the transfer-source storage group, and a normalized availability factor, which will increase for the transfer-destination storage group.

Step 10004: The processor 260 decides on a transfer-source real page of the transfer-source storage group established in Steps 10001 and 10003, and on a real page of the transfer-destination storage group established in Steps 10001 and 10003. Specifically, the processor 260 references the additional page active time 2113 of the real pages of the relevant storage group, accumulates the values thereof until these values become equivalent to a prior total value, finds the real pages, and makes these real pages the transfer-destination real pages. Naturally, it is efficient to select a large additional page active time 2113. This processing is executed for all storage groups to serve as transfer destinations. However, in this example, the transfer-source page is decided in accordance with the following restrictions:

(1) Data in a real page allocated to the cache volume is not transferred to a real page based on a different type of storage group; and

(2) data in a real page allocated to the host volume, and, in addition, data cached in a real page allocated to the cache volume is not transferred to a real page based on a flash package group 280.

The processor 260 turns ON the waiting state for transferring flag 2111 of the real page information 2100 corresponding to all the real pages to be transferred. The processor 260 also allocates a real page of the transfer-source storage group to a virtual page, which is the allocation destination of a transfer-source real page. Specifically, the processor 260 executes the following processing in proportion to the number of transfer-source real pages. That is, the processor 260 sets real page information 2100 pointed to by the empty page management information pointer 2200 corresponding to the transfer-destination storage group in the copy-destination real page pointer 2110 of the real page information 2100 for the transfer-source real page, and has the empty page management information pointer 2200 indicate the real page information 2100 for the next empty state.

Step 10005: The processor 260 clears the cumulative active time of storage 2511 of all the storages and the additional page active time 2113 for all real pages to 0 (resets to 0). Next, the processor 260 checks whether a flash package group 280 exists. In a case where a flash package group 280 exists, the processor 260 checks whether it is necessary to balance the number of block deletions by transferring data in a real page between flash package groups 280. Thus, in a case where a flash package group 280 does not exist, the processor 260 jumps to Step 10011.

Step 10006: The processor 260 adds a value to the cumulative real block allocation time in storage 2507 of the storage information 2500 corresponding to all the flash packages 230 obtained by multiplying (the next schedule time 2702−the recent schedule time 2701) by the number of allocated real blocks in storage 2505. In addition, the processor 260 adds the additional real block allocation time in storage 2509 to the cumulative real block allocation time in storage 2507. Since (the next schedule time 2702−the real block allocation time) has been added for each relevant flash package 230 real block allocated subsequent to the recent schedule time 2701, this makes it possible to reflect the allocation time of a real block allocated subsequent to the recent schedule time 2701 in the additional real block allocation time in storage 2509. In addition, the processor 260 sets the additional real block allocation time in storage 2509 to 0. The processor 260 also adds the number of additional allocated real blocks 2506 to the number of allocated real blocks in package 2505, and sets the number of additional allocated real blocks 2506 to 0.

Step 10007: The processor 260 adds a value obtained by multiplying (the next schedule time 2702−the recent schedule time 2701) by the number of additional allocated real blocks 2105 to the cumulative real block allocation time 2106 of the real page information 2100 corresponding to all the real pages. In addition, the processor 260 adds the additional real block allocation time 2108 to the cumulative real block allocation time 2106. Since (the next schedule time 2702−the allocation time) has been added for each real block of a relevant real page allocated subsequent to the recent schedule time 2701, this makes it possible to reflect the allocation time of a real block allocated subsequent to the recent schedule time 2701 in the additional real block allocation time 2108. In addition, the processor 260 sets the additional real block allocation time 2108 to 0. The processor 260 also adds the number of additional allocated real blocks 2105 to the number of allocated real blocks 2104, and sets the number of additional allocated real blocks 2105 to 0.

Step 10008: The processor 260 divides the cumulative real block deletion times in storage 2508 of the storage information 2500 corresponding to all flash packages 230 by the cumulative real block allocation time in storage 2507. This value becomes the average number of deletions per unit of time for the real blocks of each flash package 230 in a case where a real page allocation change has not been carried out. In addition, the processor 260 divides the number of allocated real blocks in storage 2505 of the storage information 2500 corresponding to all flash packages 230 by the number of allocatable real blocks. This value constitutes the real block occupancy of each flash package 230 in a case where a real page allocation change has not been carried out. In this example, in a case where this average number of deletions is equal to or larger than a fixed value (the life expectancy of the flash package 230 is short), is larger than equal to or larger than a fixed percentage compared to another flash package 230 (the bias of the average number of deletions between flash packages 230 is large), or has an occupancy of equal to or larger than a fixed value (the flash package 230 is likely to become full), the processor 260 transfers data in a real page based on the flash package group 280 comprising this flash package 230 to a real page of another flash package group 280. The processor 260 may also transfer the data in a real page based on the flash package group 280 comprising this flash package 230 to a real page of another flash package group 280 when the number of allocatable real blocks 2504 has ceased to satisfy a certain criterion. At this point, the processor 260 decides which flash package group 280 real page data to transfer. In addition, the processor 260 references the average number of deletions per unit of time for the real blocks, the real block occupancy, and the number of allocatable real blocks of each of the above-mentioned flash packages 230, and decides the flash package group 280, which will constitute the transfer destination.

Step 10009: The processor 260 decides which real page data is to be transferred from among multiple real pages based on the flash package group 280 decided as the real page transfer source. At this point, the processor 260 decides the transfer-source real page by referencing the cumulative real block allocation time 2106, the cumulative number of real block deletions 2107, and the number of allocated real blocks 2104 of the respective real page information 2100 belonging to all the flash package groups 280 constituting transfer sources. The processor 260 also turns ON the waiting state for transferring flag 2111 of the real page information 2100 corresponding to all the real pages to be transferred.

Step 10010: The processor 260 decides which real page in the transfer-destination flash package group 280 decided in Step 10002 to make the transfer destination of the real page for which transfer was decided in Step 10009 (the real page corresponding to the real page information 2100 for which the waiting state for transferring flag 2111 was turned ON). The processor 260 decides the transfer-destination real page by referencing the number of real pages 2303 and the number of empty real pages 2304 of the storage group information 2300 corresponding to the flash package group 280, which was made the transfer destination, and the number of allocatable real blocks 2504, the number of allocated real blocks in storage 2505, the cumulative real block allocation time in storage 2507, and the cumulative real block deletion times in storage 2508 of the storage information 2500 corresponding to the flash packages 230 belonging to the relevant flash package group 280. The processor 260, upon deciding the transfer-destination real page, sets the real page information 2100 pointed to by the empty page management information pointer 2200 corresponding to the transfer-destination flash package group 280 in the copy-destination real page pointer 2110 of the real page information 2100 for the transfer-source real page. The processor 260 makes the empty page management information pointer 2200 indicate the real page information 2100 for the next empty state. The processor 260 executes the above processing for all the real pages for which the decision to transfer was made in Step 10003. In accordance with the above, a transfer-destination page is decided for each transfer-source real page of the set of real pages constituting transfer sources.

Step 10011: The processor 260 drives the page transfer process execution part 4500 corresponding to a storage group, which has at least one real page constituting a transfer source, from among the page transfer process execution parts 4500, which exists for each storage group.

Step 10012: The processor 260 calls the storage selection part 4700.

Step 10013: The processor 260 copies the next schedule time 2702 to the recent schedule time 2701. Next, the processor 260 sets the next schedule time in the next schedule time 2702.

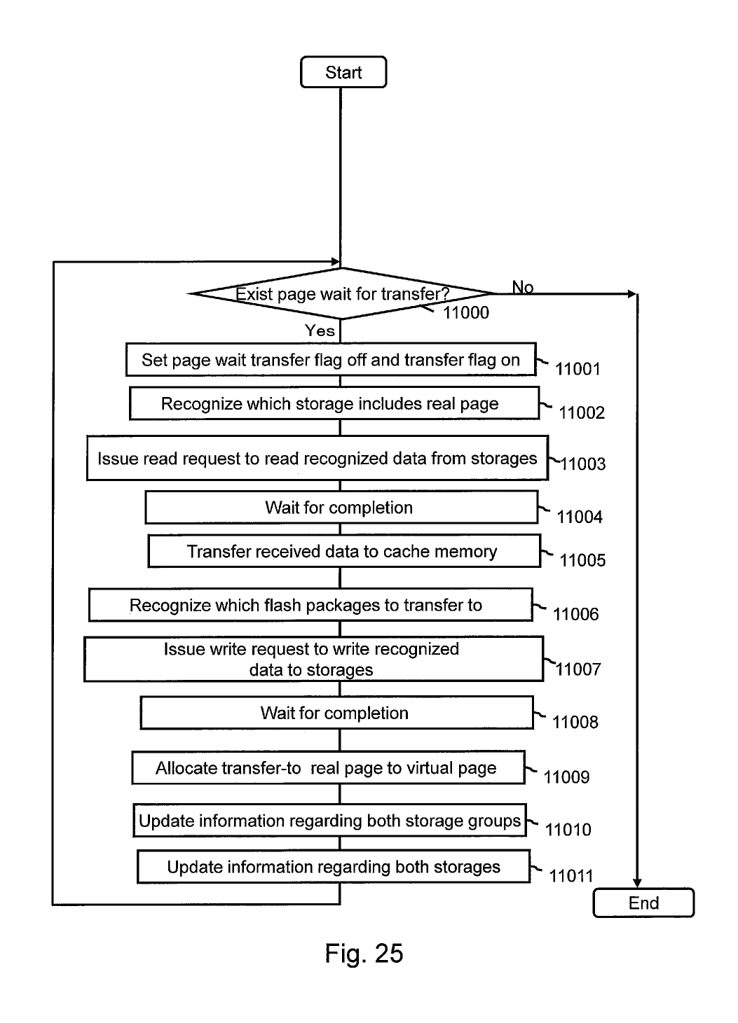

FIG. 25 is the flow of processing of the page transfer process execution part 4500. The page transfer process execution part 4500 exists for each flash package group 280. As was described in Step 10011 of FIG. 24, the page transfer process execution part 4500 corresponding to a flash package group 280, which has at least one real page constituting a transfer source, is called from the transfer page schedule part 4400 in the corresponding flash package group 280.

Step 11000: The processor 260 searches the real page information 2100 for which the waiting state for transferring flag 2111 has been turned ON in the corresponding flash package group 280. The real page corresponding to this real page information 2100 will be the transfer source (copy source). A case in which real page information 2100 for which the waiting state for transferring flag 2111 has been turned ON does not exist signifies that all the processing for real pages to be transferred in the relevant flash package group 280 has been completed, and the processor 260 ends the processing.

Step 11001: The processor 260 turns OFF the waiting state for transferring flag 2111 and turns ON the transferring flag 2109 of the relevant real page information 2100.

Step 11002: At this point, the processor 260 calculates a length involved in a real page corresponding to the relevant real page information 2100 being read with respect to a storage, which comprises the storage group to which the real page is allocated, and a relative address in the storage. The storage group information 2300 showing a storage group 2101 of the real page information 2100 is the relevant storage group information 2300. The storage, which corresponds to the storage information 2500 indicated by the storage pointer 2305 stored in this storage group information 2300, is the storage to which the copy-source real page is allocated. Next, the processor 260 determines the real page address 2102 of the real page information 2100, and the transfer-target relative address and length in each storage from the storage information 2500 for all the storages.

Step 11003: The processor 260 requests that the storages, which comprise the storage group to which the transfer-source real page is allocated, transfer data of the specified length from the specified relative address.

Step 11004: The processor 260 waits for completion reports from all the storages to which the request was issued.

Step 11005: The information, which is returned from the storage, is stored in a storage other than a flash package 230. In the case of a flash package 230, this example supports a lower-level capacity virtualization function, and as such, information such as that which follows is returned. In other words, information denoting whether a real block has been allocated to each virtual block is returned. In a case where a real block has been allocated, this information may comprise the stored data, the time at which a real block (not necessarily the real block currently allocated) was first allocated to this virtual block from a real block non-allocation state, and the number of deletions of the real block, which was allocated to this virtual block subsequent to this time. The processor 260 stores this information on the cache memory 210.

Step 11006: At this point, the processor 260 calculates the set of storages, which comprise the storage group to which the relevant real page is allocated, and the relative address of each storage and length with respect to the transfer-destination real page. In accordance with this, the real page information 2100 shown by the transfer-destination real page address of the transfer-source real page information 2100 is the real page information 2100 corresponding to the transfer-destination real page. The process for calculating the set of storages, which comprise the storage group, and the relative address of each storage and length with respect to the virtual block based on the real page information 2100 was explained in Step 11002, and as such, an explanation thereof will be omitted here.

Step 11007: The processor 260 requests each storage comprising the storage group to which the transfer-destination real page is allocated to store data of the prescribed length from the prescribed relative address. The information sent to each storage at this time is sent from the storage, which constitutes the transfer source stored in the cache in Step 11005.

Step 11008: The processor 260 waits for completion reports from all the storages to which the request was issued.

Step 11009: The processor 260 allocates the transfer-source real page to an empty real page, and the virtual page to which the transfer-source page had been allocated up until now to the transfer-destination page. This may be realized by linking the transfer-source real page to the empty page management information pointer 2200, and having the real page pointer 2004, which had indicated the transfer-source real page information up until now, indicate the transfer-destination real page information. The processor 260 also copies the number of allocated real blocks 2104, the number of additional allocated real blocks 2105, the cumulative real block allocation time 2106, the cumulative number of real block deletions 2107, and the additional real block allocation time 2108 from among the transfer-source real page information to the transfer-destination real page information 2100. After the copy, the processor 260 clears the number of allocated real blocks 2104, the number of additional allocated real blocks 2105, the cumulative real block allocation time 2106, the cumulative number of real block deletions 2107, and the additional real block allocation time 2108, the moving state flag 2109, the transfer to real page pointer 2110, and the waiting state for transferring flag 2111 of the transfer-source real page information 2100 (resets these items to prescribed values).

Step 11010: The processor 260 updates all the storage group information 2300 constituting the transfer source, and all of the storage group information 2300 constituting the transfer destination. At this point, the processor 260 decreases by one the number of real pages 2303 of the storage group information 2300 constituting the transfer source, and increases by one the number of real pages 2303 of the storage group information 2300 constituting the transfer destination for each set of a transfer-source real page and a transfer-destination real page.

Step 11011: The processor 260 updates all the storage information 2500 constituting the transfer source and all the storage information 2500 constituting the transfer destination. At this point, the processor 260 decreases the values of the number of allocated real blocks 2104, the cumulative real block allocation time 2106, and the cumulative number of real block deletions 2107 corresponding to the respective flash packages 230 in the real page information 2100 of the transfer-destination real page based on the values of the number of allocated real blocks in storage 2505, the cumulative real block allocation time in storage 2507, and the cumulative real block deletion times in storage 2508 of the respective storage information 2500 constituting the transfer sources. The processor 260 also adds the values of the number of allocated real blocks 2104, the cumulative real block allocation time 2106, and the cumulative number of real block deletions 2107 corresponding to the respective flash packages in the real page information 2100 of the transfer-destination real page to the values of the number of allocated real blocks in storage 2505, the cumulative real block allocation time in storage 2507, and the cumulative real block deletion times in storage 2508 of the respective storage information 2500 constituting the transfer destinations. Thereafter, the processor 260 returns to Step 11000.

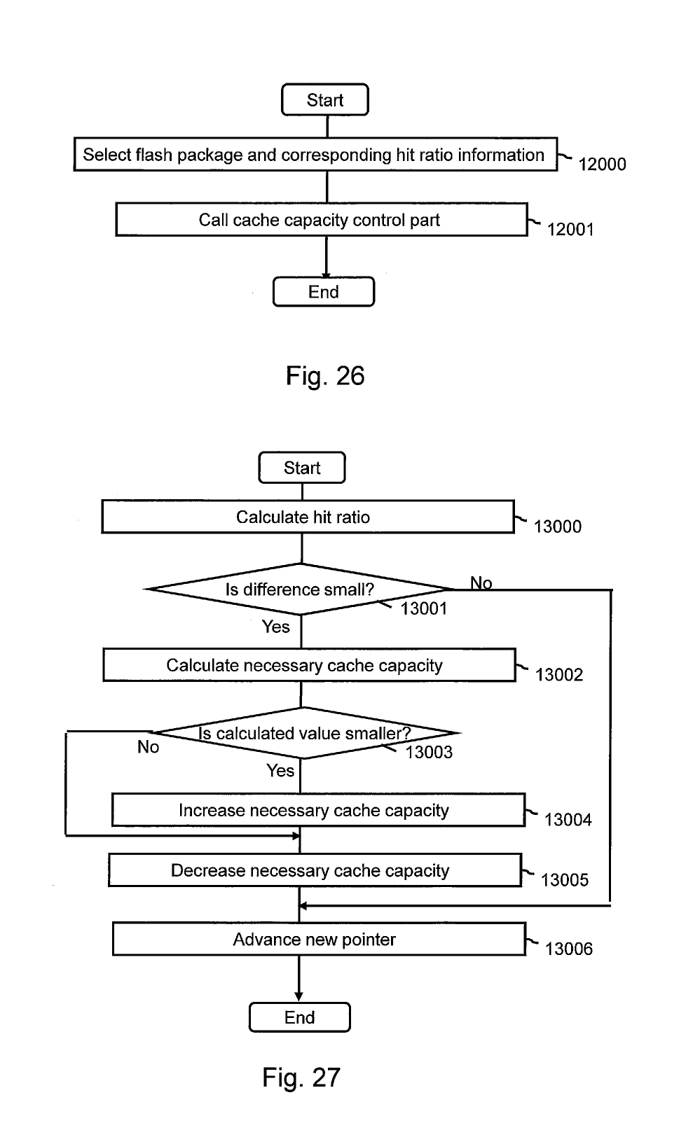

FIG. 26 is the flow of processing of the storage selection part 4700. The storage selection part 4700 is called by the transfer page schedule part 4400.

Step 12000: In Example 1, the caching destination is a flash package 230. The processor 260 selects a flash package 230 and corresponding hit ratio information 2980. The processor 260 also sets information such that the selected storage is a flash package 230.

Step 12001: The processor 260 calls the cache capacity control part 4600.

FIG. 27 is the flow of processing of the cache capacity control part 4600. The cache capacity control part 4600 is called by the transfer page schedule part 4400.

Step 13000: The processor 260 calculates the hit ratio for this schedule period based on the number of hits 1603 and the number of misses 1604 pointed to by the new pointer 1601 of the specified hit ratio information 2980.

Step 13001: The processor 260 calculates the difference between the hit ratio calculated in Step 13000 and the aiming hit ratio 1600, and determines whether this difference falls within a prescribed range. In a case where the difference falls within the prescribed range, the processor 260 jumps to Step 13006.

Step 13002: In a case where the difference does not fall within the prescribed range, the processor 260 predicts the cache capacity required to achieve the aiming hit ratio 1600 based on the past cache capacity 1602, the number of hits 1603 and the number of misses 1604. Specifically, for example, the processor 260 predicts the cache capacity for achieving the aiming hit ratio 1600 based on a past hit ratio calculated on the basis of a past cache capacity 1602 and the number of misses 1604. More specifically, for example, the processor 260 can approximately calculate a function, which produces hit ratio=F(X) (where X is the cache capacity) based on the relationship between the a past cache capacity and a past hit ratio, input the aiming hit ratio into this function, and use the obtained value as a predictive value for the cache capacity. Next, the processor 260 advances the new pointer 1601 by one. The processor 260 sets the predicted cache capacity in the cache capacity 1602 indicated by the new pointer 1601, and clears the number of hits 1603 and the number of misses 1604 to 0 (resets these items to 0).

Step 13003: In a case where the set cache capacity 1602 is larger than the past (one prior to the new pointer 1601) cache capacity 1602, the processor 260 jumps to Step 1305.

Step 13004: In accordance with this, the processor 260 must increase the cache area based on the storage. At this point, the processor 260 obtains the required number of empty real pages from the specified storage group. For example, the processor 260 proportionally obtains real pages from the storage groups via an empty page management information queues 2201, and allocates a real page in the cache volume 200 to an unallocated virtual page. Next, the processor 260 calculates the number of effective segments from the number of segments per virtual page and the number of allocated virtual pages, fetches this number of segment management information 2850 from the ineffective segment queue 1302 of the corresponding storage, and links this information 2850 to the empty segment queue 1301. At this time, the processor 260 sets the relevant logical volume identifier and the relative address in the segment address 1501 of each piece of segment management information 2850.

Step 13005: In accordance with this, the processor 260 must decrease the cache capacity of the storage. At this point, the processor 260 decides on a real page to be returned (that is, decides on a real page, which changes from a real page capable of being allocated to the cache volume to a real page capable of being allocated to the host volume), returns the segment management information 2850, which is already in the empty state, to the ineffective segment queue 1302, adds the segment management information 2850, which is storing data, to a LRU location, and when the segment management information 2850 has transitioned to the empty state, returns this information 2850 to the ineffective segment queue 1302. Therefore, the processor 260 calculates the number of real pages to be decreased based on the cache capacity calculated in Step 13002, and decides on the real page(s) to be released from the virtual page. Then, the processor 260 turns ON the page returning flag 2008 corresponding to the relevant virtual page in the logical volume information 2000. In addition, the processor 260 searches the empty segment queue 1301, and returns the segment management information 2850 of the segments included in the corresponding real page to the ineffective segment queue 1302. At this time, the processor 260 subtracts the number of segments, which were returned to the ineffective segment queue 1302, from the number of segments included per page. In a case where the post-subtraction value is 0, all the segments can be made ineffective, and as such, the processing performed in a case where the post-subtraction value is not 0 is not carried out. In a case where the post-subtraction value is not 0, the processor 260 turns ON the page returning flag 2008 corresponding to the relevant virtual page in the logical volume information 2000, and sets the subtracted value in the number of using segments 2007.

Step 13006: The processor 260 advances the new pointer 1601 by one. The processor 260 sets the previous cache capacity 1602 to the cache capacity 1602 indicated by the new pointer 1601, and clears the number of hits 1603 and the number of misses 1604 to 0.

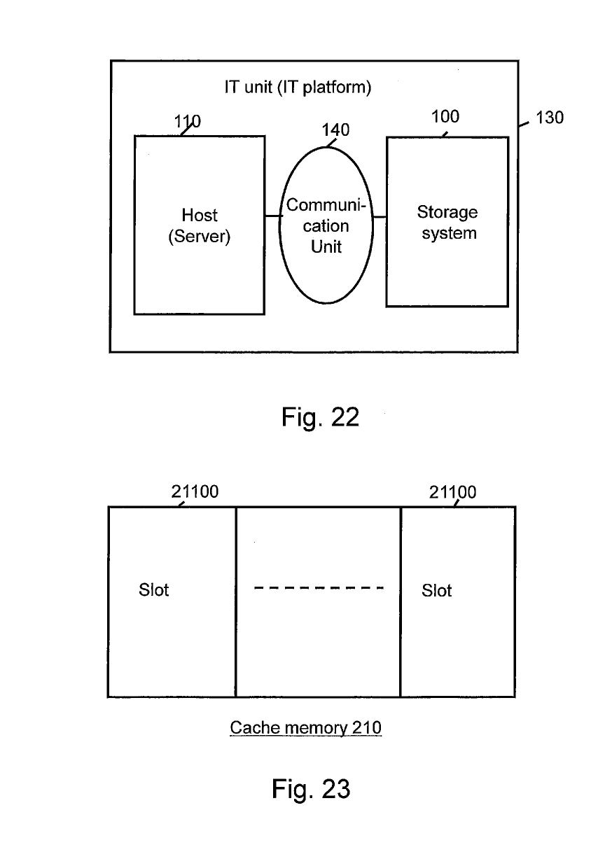

FIG. 22 is an example of another configuration of the information system in Example 1.

In the configuration of FIG. 1, the storage system 100 is connected to the host 110 via a SAN 120. Alternatively, in FIG. 22, the host 110 and the storage system 100 are mounted in a single IT unit (IT platform) 130, and are connected by way of a communication unit 140. The communication unit 140 may be either a logical unit or a physical unit. The present invention is effective in this configuration as well, and similarly is effective in the storage system 100 configuration and functions explained up to this point as well.

### Example 2

Example 2 will be explained below. In so doing, the points of difference with Example 1 will mainly be explained, and explanations of the points in common with Example 1 will either be simplified or omitted.

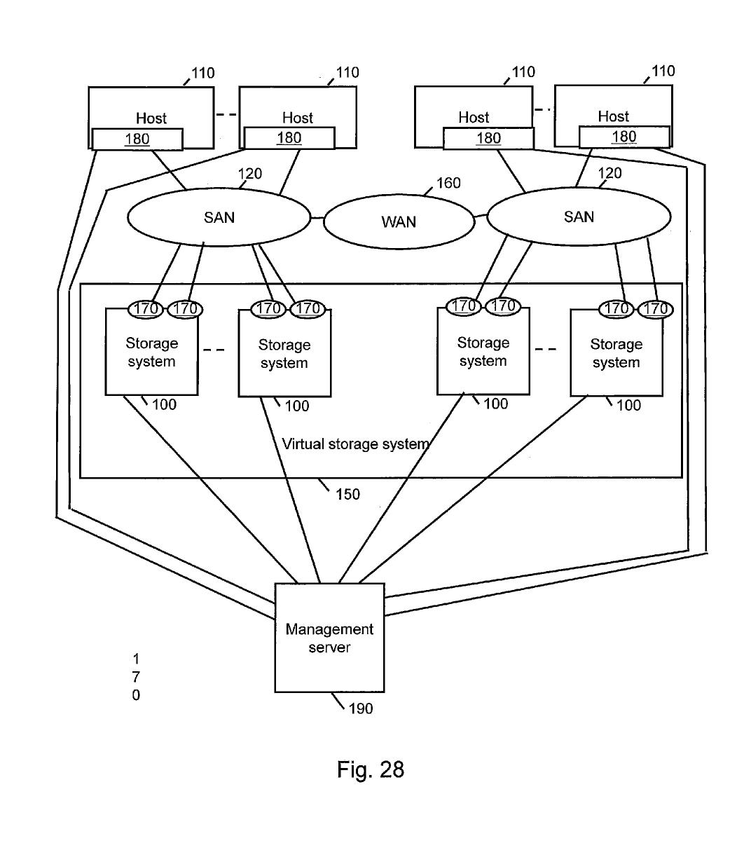

FIG. 28 is a block diagram of an information system in Example 2.

In Example 2, a virtual storage system 150 configured using multiple storage systems 100 exists. In this example, there is one virtual storage system 150, but the present invention is effective even when multiple virtual storage systems 150 exist. It is supposed that the respective storage systems 100 are connected via the SAN 120. In addition, the storage system 100 may also comprise components, which are connected via a WAN 160. In accordance with this, it is supposed that the distance between storage systems 100 becomes fairly long, but that these storage systems 100 are included in a single virtual storage system 150. In this example, it is supposed that all the storage systems 100 comprising the virtual storage system 150 are able to communicate with one another via the SAN 120 and the WAN 160. However, the present invention is effective even when communications are not possible among the storage systems 100 comprising the virtual storage system 150. The multiple storage systems 100 in the virtual storage system 150 may be connected in series. The host 110 theoretically recognizes the virtual storage system 150 without recognizing the individual storage systems 100. The host 110 is physically connected to at least one storage system 100 comprising the virtual storage system 150. The host 110 accesses a storage system to which the host 110 is not directly connected by way of a storage system 100 comprising the virtual storage system 150. The individual storage systems 100 have two types of identifiers, i.e., the identifier of the virtual storage system 150 to which this storage system 100 belongs, and the identifier of this storage system 100. A port 170 is a unit for receiving a request (a read request and a write request) from the host 110, and the host 110 issues a read request and a write request by specifying the port 170 and the virtual logical volume. The virtual logical volume is a logical volume defined inside the virtual storage system 150, and the identifier of the virtual logical volume is unique inside the virtual storage system 150. The virtual logical volume is a logical volume in which one or more logical volumes of one or more storage systems have been virtualized. The storage controller 200 in a storage system 100, in a case where an access request (either a read request or a write request) specifying a virtual logical volume access destination has been received and the storage system 100 comprises the logical volume corresponding to this access destination, accesses this logical volume, and in a case where another storage system 100 comprises the logical volume corresponding to this access destination, transfers the above-mentioned access request to this other storage system 100 via 0 or more storage systems 100. A response from the other storage system 100, which received the above-mentioned access request, may be received by the transfer-source storage system 100 by way of 0 or more storage systems 100 via which the access request was transferred. The storage controller 200 in the storage system 100, which receives the response, may send this response to the host 110. A management server is for managing the host 110 and the virtual storage system 150. In the configuration of FIG. 28, the management server 190 exists, but this example is effective even in a case where a management server does not exist.

In Example 2, the storage system 100 caches data inside another storage system 100 comprising the virtual storage system 150 to a storage (cache volume) of the relevant storage system 100.

Example 2 differs from Example 1 in that the data of another storage system 100 is cached in a storage of the relevant storage system 100. Hereinafter, a storage system, which receives and caches a read request/write request, will be referred to as a “first storage system”, and a storage system, which either stores read-target data or constitutes the storage destination of write-target data, will be referred to as a “second storage system”. Specifically, for example, the following processing is carried out in Example 2. In order for the first storage system 100 to cache data of the second storage system 100, the first storage system 100 must be able to receive a read request/write request from the host 110. Therefore, in Example 2, multiple storage systems define a single virtual storage system 150, and it appears to the host 110 that the virtual storage system 150 has all of the ports 170 possessed by the individual storage systems 100 for receiving a read request/write request. The host 110 possesses port information 180 of the virtual storage system 150, but the first storage system 100, which performs caching, is able to receive a read request/write request to the second storage system 100, which stores data, and perform the caching by issuing a notification for changing the port 170 for receiving the read request/write request.

In Example 2, since the first storage system 100 caches the data of the second storage system 100, in a case where the accessed data results in a hit (exists in the cache), the time it takes to transfer the data from the second storage system 100, which stores the data, to the first storage system 100 for caching can be shortened as seen from the accessing host 110. Thus, caching should be performed by taking into account the fact that this time is able to be shortened. As such, each storage system 100 decides which storage in its own storage system 100 to cache data from which storage system 100 comprising the virtual storage system 150. This is decided in accordance with the effect to be obtained by the accessing host 100 as a result of performing caching. The effect, first of all, is that caching to a storage system 100 to shorten host access time is efficient. That is, in a case where the second storage system 100 in which the data is stored is far away from the host 110 accessing the data, caching using the first storage system 100, which is close to the host 110, makes it possible to reduce the time for transferring the data to the host 110. In a case where the storage systems 100 are connected via a network with a long latency time in which the distance between the storage systems 100 is long, the effect of caching is great. Thus, the present invention is effective even when data is cached to a storage with identical access performance as that of a storage in which data is stored permanently. In some cases, the present invention can be expected to be effective even when this data is cached to a storage with access performance somewhat lower than that of a storage in which data is stored permanently. Thus, caching should be performed by taking into account the data transfer time between storage systems 100.

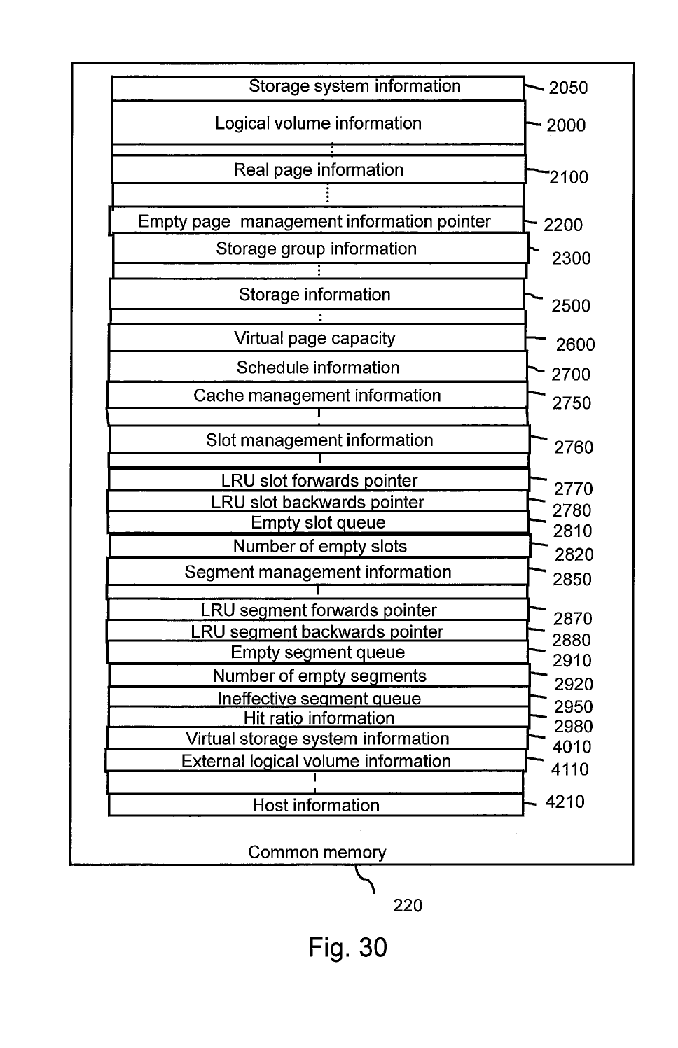

FIG. 30 shows information stored in a common memory 220 of the storage system 100 in Example 2.

In Example 2, virtual storage system information 4010, external logical volume information 4110, and host information 4210 is also stored in the common memory 220.

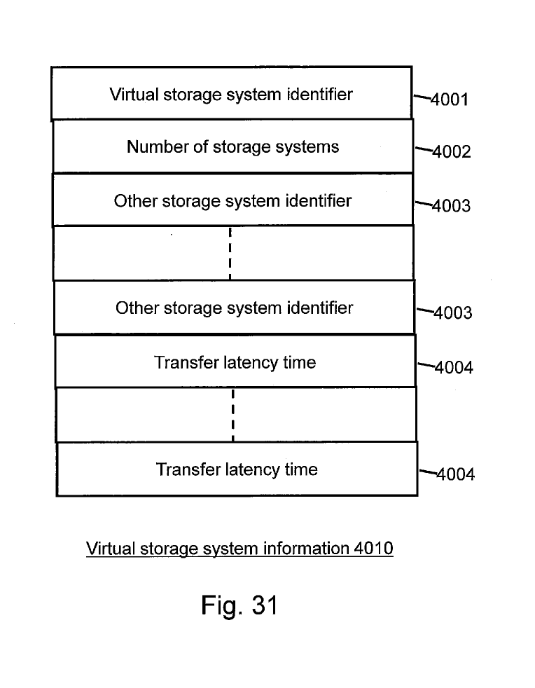

FIG. 31 shows the configuration of the virtual storage system information 4010.

The virtual storage system information 4010 comprises a virtual storage system identifier 4001, the number of storage systems 4002, other storage system identifier 4003, and a transfer latency time 4004.

The virtual storage system identifier 4001 is the identifier for the virtual storage system 150 to which the relevant storage system 100 belongs. The number of storage systems 4002 is the number of storage systems 100 comprising this virtual storage system 150. The other storage system identifier 4003 and transfer latency time 4004 exist in proportion to a number, which is one smaller than the number comprising the number of storage systems 4002. These are pieces of information related to another storage system 100 belonging to the virtual storage system 150 to which the relevant storage system 100 belongs. The other storage system identifier 4003 is the identifier for the other storage system 100, and the transfer latency time 4004 is the latency time when data is transferred between the relevant storage system 100 and the other storage system 100.

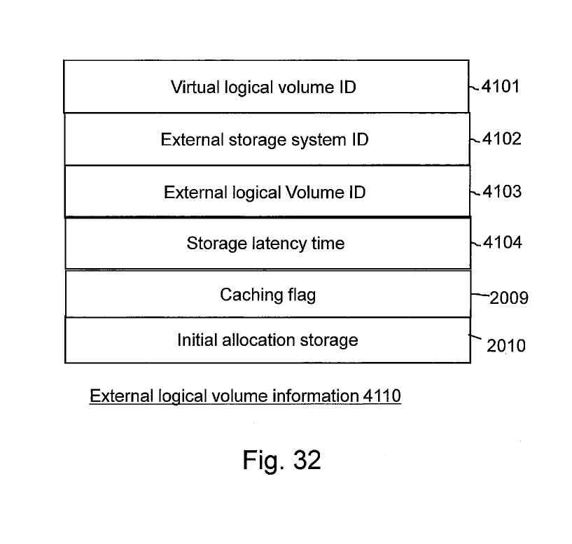

FIG. 32 shows the configuration of the external logical volume information 4110.

The external logical volume information 4110 comprises a virtual logical volume ID 4101, an external storage system ID 4102, an external logical volume ID 4103, a storage latency time 4104, a caching flag 2009, and an initial allocation storage 2010. The external logical volume information 4110 exists for each logical volume of the other storage system 100 comprising the virtual storage system 150 to which the relevant storage system belongs.

The virtual logical volume ID 4101 is the virtual logical volume identifier of the relevant external logical volume. The external storage system ID 4102 and the external logical volume ID 4103 are information for the relevant virtual logical volume to identify which logical volume of which storage system 100. In Example 2, the host 110 specifies the identifier of the virtual storage system, the identifier of the port 170, and the identifier of the virtual logical volume when issuing a read request/write request. The storage system 100 receives the read request/write request from the specified port 170. The storage system 100 sees the virtual logical volume specified in the request, references the external logical volume information 4110 and the logical volume information 2000, and determines which logical volume of which storage system 100 the request is for. In a case where the specified virtual logical volume is included in the virtual logical volume ID 4101 in the information of the external logical volume 4110, the specified logical volume is a logical volume of an external storage system 100. The storage latency time 4104 is the latency time of a storage in the other storage system 100. Therefore, the transfer latency time 4004 and the storage latency time 4104 constitute the actual latency. In Example 2, the initial allocation storage 2010 is any of a NULL state, an ineffective, a flash package 230, a high-speed disk unit 265, or a low-speed disk unit 290. The NULL state is when a determination has not been made as to whether or not the relevant logical volume should be cached. In a case where this determination is made and caching is to be performed (the caching flag is ON), the initial allocation storage 2010 shows any of the flash package 230, the high-speed disk 265, or the low-speed disk 290.

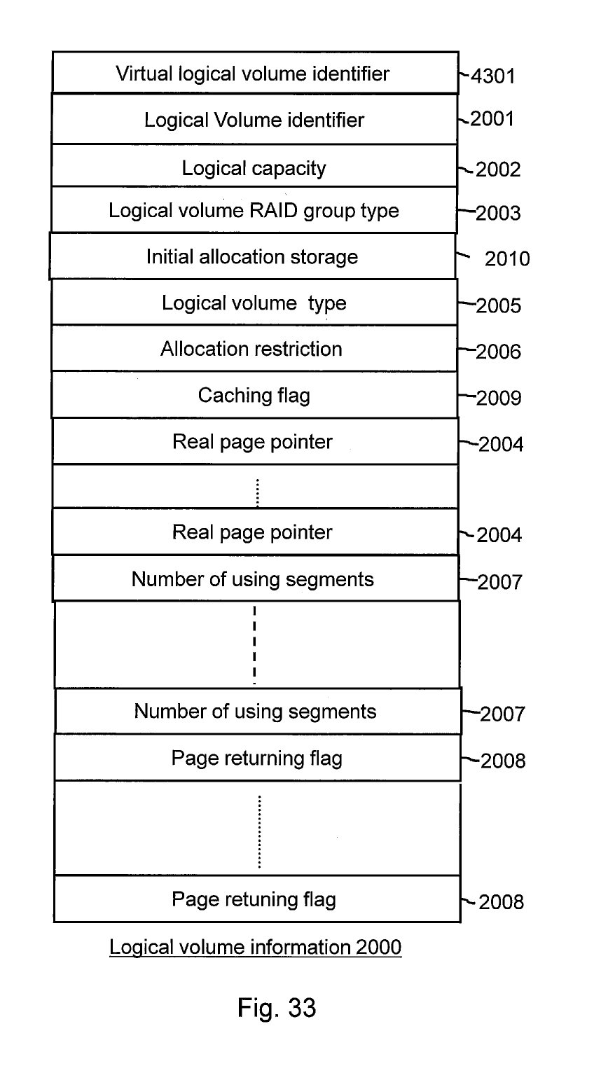

FIG. 33 is the configuration of the logical volume information 2000 of Example 2.

In Example 2, the logical volume information 2000 exists for each logical volume inside the relevant storage system 100. In Example 2, the host 110 specifies a virtual logical volume. Therefore, the logical volume information 2000 of Example 2 comprises a virtual logical volume identifier 4301. In a case where the virtual logical volume specified by the host 110 is the volume shown by the virtual logical volume identifier 4301 in the logical volume information 2000, the specified logical volume is a logical volume of the relevant storage system 100. Otherwise, it is the same as Example 1. In this example, a storage system performs caching for data of an external logical volume shown by the external storage system ID 4102 and the external logical volume identifier 4103, and the caching-destination storage is included in the relevant storage system 100. At this time, a caching volume is defined the same as in Example 1, but since this caching volume is an internal logical volume, this caching volume is defined in the logical volume information 2000 shown in FIG. 33. The caching volume does not constitute a specification target for a read request/write request from the host, and as such, the virtual logical volume identifier 4301 may be a NULL state.

FIG. 40 is the configuration of the host information 4210.

The host information 4210 is information about a host 110 connected to the relevant storage system 100, and comprises the number of connected hosts 4201, a host ID 4202, a host latency time 4203, the number of connected ports 4204, and a connected port ID 4205.

The number of connected hosts 4201 is the number of hosts 110 connected to the relevant storage system 100. The host ID 4202 and the host latency time 4203 are information that exist for each connected host. The host ID 4202 is the identifier of the corresponding host 110. The host latency time 4203 is the latency time, which occurs pursuant to a data transfer between the relevant storage system 100 and the corresponding host 110. The number of connected ports 4204 is the number of ports 170 in the relevant storage system 100 accessible by the corresponding host 110. The connected port ID 4205 is the identifier of the port 170 of the relevant storage system 100 accessible by the corresponding host 110, and exists in proportion to the number of connected ports 4204.

The configuration of the cache management information 2750 of Example 2 is the same as in Example 1. The cached address 2757 shows the logical volume and the relative address thereof of the data stored in a slot 21100 (or segment) corresponding to the relevant cache management information 2750, but in the case of Example 2, the logical volume constitutes either the logical volume of the relevant storage system 100 or the logical volume of the other storage system 100. In the case of the other storage system 100, the identifier of this storage system 100 is included in the cached address 2757.

The empty segment queue 1301 and the ineffective segment queue 1302 were valid for information corresponding to a flash package 230 in Example 1, but in Example 2, the empty segment queue 1301 and the ineffective segment queue 1302 are valid for any of the flash package 230, the high-speed disk 265, and the low-speed disk 290. The hit ratio information 2980 is also valid for the hit ratio information 2980 of any of the flash package 230, the high-speed disk 265, and the low-speed disk 290.

Other than the points mentioned hereinabove, the storage system 100-held information in Example 2 may be the same as that for Example 1.

In Example 2, the host 110 has port information 180.

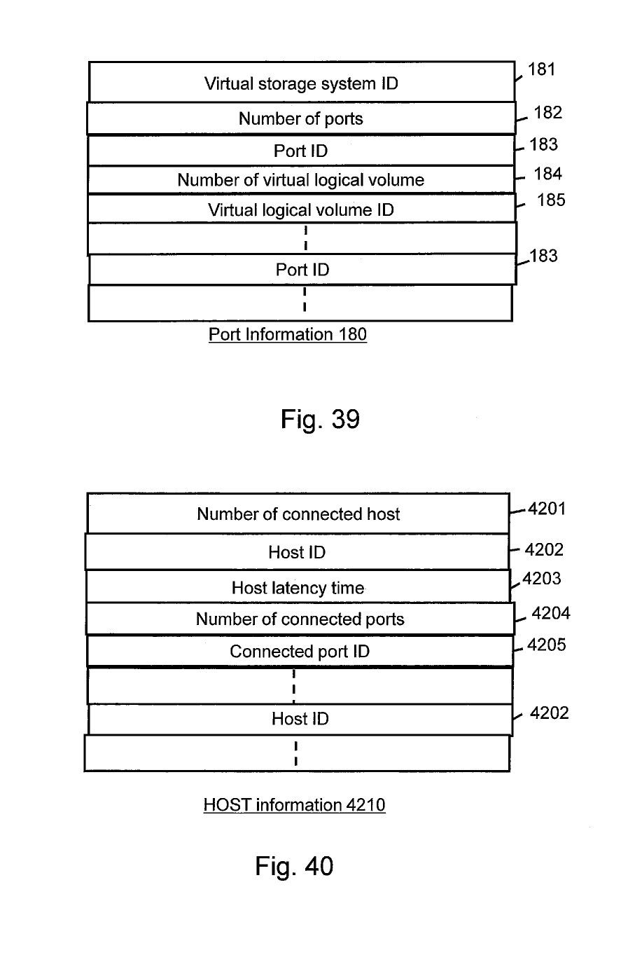

FIG. 39 is the format of the port information 180.

The port information 180 comprises a virtual storage system ID 181, the number of ports 182, a port ID 183, the number of virtual logical volumes 184, and a virtual logical volume ID 185. In this example, there is one virtual storage system 150, but the present invention is effective even when there are multiple virtual storage systems 150.

The virtual storage system ID 181 is the identifier for the virtual storage system 150 connected to the relevant host 110. The number of ports 182 is the number of ports 170 possessed by the virtual storage system 150. Although each storage system 100 actually has ports 170, it is made to appear to the host 110 like these ports 170 belong to the virtual storage system 150. The port ID 183 is the identifier of a port 170 possessed by the virtual storage system 150. Therefore, there are as many port IDs 183 as there are number of ports 182. The number of virtual logical volumes 184 is the number of virtual logical volumes accessible from the respective ports 170. The virtual logical volume ID 185 is the identifier for a virtual logical volume accessible from the corresponding port 170. Therefore, there are as many virtual logical volume IDs 185 as there are number of virtual logical volumes for the corresponding port 170. Since one virtual logical volume may be accessed from multiple ports 170, the identifier for the same virtual logical volume may be defined in the virtual logical volume ID 185 of different ports 170.

Next, the operations executed by the storage controller 200 in Example 2 will be explained using the management information explained hereinabove.

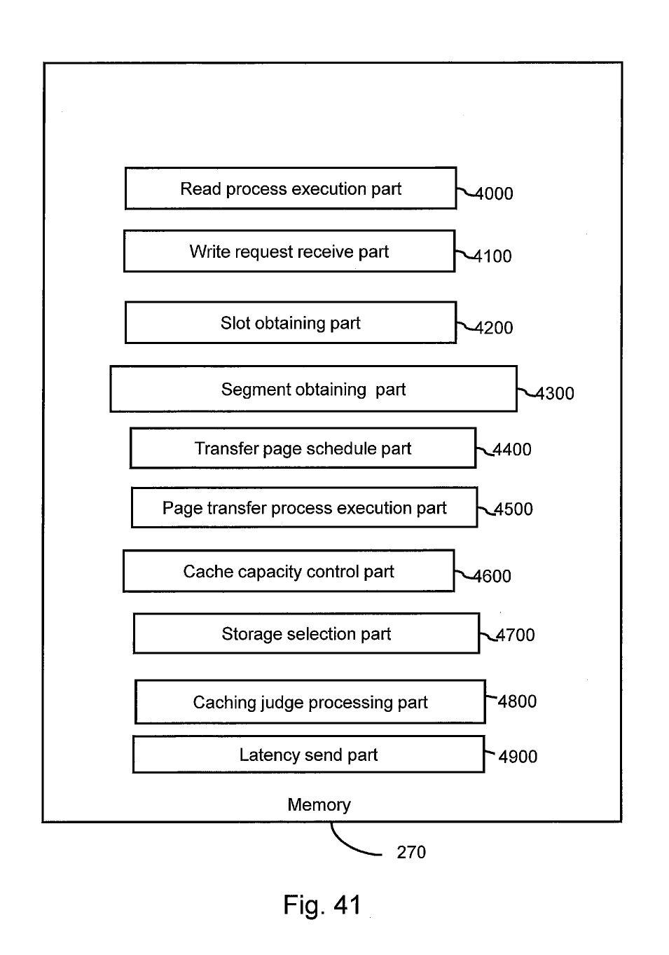

FIG. 41 shows the programs in the memory 270, which are executed by the processor 260 in Example 2.

In Example 2, in addition to the respective programs shown in FIG. 17, there exist a caching judge processing part 4800 and a latency send part 4900. However, the read process execution part 4000, the write request receive part 4100, the slot obtaining part 4200, the segment obtaining part 4300, and the storage selection part 4700 differ from those of Example 1.

First, the caching judgeprocessing part 4800 and the latency send part 4900 will be explained. Next, the functions of the read process execution part 4000, the write request receive part 4100, the slot obtaining part 4200, the segment obtaining part 4300, and the storage selection part 4700, which differ from those of Example 1, will be explained.

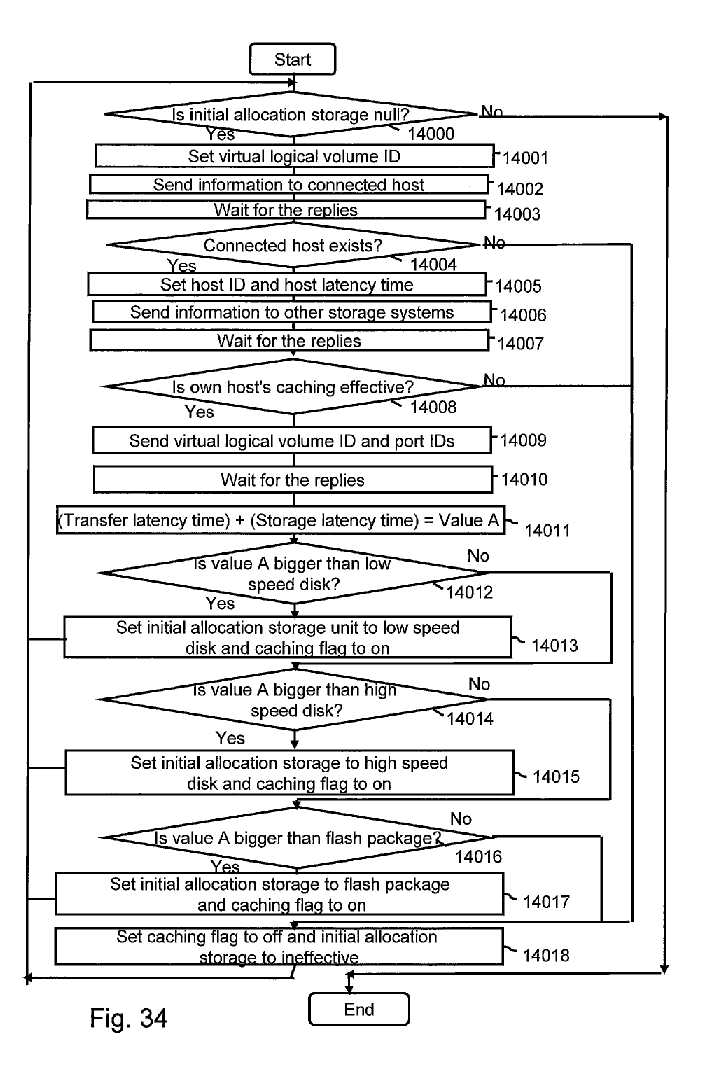

FIG. 34 is the flow of processing of the caching judge processing part 4800. The caching judge processing part 4800 is processed by the processor 260 on an appropriate cycle.

Step 14000: At this point, the processor 260 searches among the logical volumes on the other storage system 100 for external logical volume information 4110 with NULL in the initial allocation storage 2010. In a case where this information 4110 cannot be found, the processor 260 ends the processing.

Step 14001: In order to determine whether caching should be performed for the relevant storage system 100 at this point, first the processor 260 fetches the identifier of the virtual logical volume from the virtual logical volume ID 4101 of the discovered external logical volume information 4110.

Step 14002: The processor 260 sends the virtual logical volume identifier to all the connected hosts 110 to check whether the relevant virtual logical volume is being accessed by the host 110 connected to the relevant storage system 100. This transmission may be carried out by way of the SAN 120 and the WAN 160, or via the management server 190.

Step 14003: The processor 260 waits for a reply from the host 110.

Step 14004: The processor 260 checks whether there is a host 110, which is accessing the corresponding virtual logical volume, among the hosts 110 connected to the relevant storage system 100. In a case where there is no accessing host 110, the processor 260 jumps to Step 14018.

Step 14005: The processor 260 fetches the host ID 4202 and the host latency time 4203 of the host 110 accessing the relevant virtual logical volume.

Step 14006: The processor 260 sends the identifier of the virtual logical volume recognized in accordance with these fetched values to the other storage systems 100 comprising the virtual storage system 150.

Step 14007: The processor 260 waits for replies to be returned.

Step 14008: At this point, the processor 260 determines whether caching would be effective for the relevant storage system 100. First of all, the processor 260 compares the host latency time 4203 of the relevant storage system 100 to the latency time with the host 110, which has been sent from the storage system 100 comprising the logical volume corresponding to this virtual logical volume, and in a case where the host latency time 4203 of the relevant storage system 100 is smaller than a certain range, allows for the possibility of caching for the relevant storage system 100. This is because it is considered to be better for the host 110 to directly access the storage system 100 comprising this logical volume when the latency time is rather short. Whether the storage system 100 comprises this logical volume or not can be determined using the external storage system ID 4102 included in the external logical volume information 4110 recognized in Step 14000. Next, the processor 260 compares the host latency time 4203 of the relevant storage system 100 to the latency times returned from the remaining storage systems 100, and when the host latency time 4203 of the relevant storage system 100 is the shortest, determines that caching would be effective for the relevant storage system 100. When this is not the case, the processor 260 jumps to Step 14017.

Step 14009: The processor 260 sends the corresponding host the identifier of the port 170 connected to the corresponding host 110 and the identifier of the virtual logical volume for issuing the relevant storage system access to the corresponding virtual logical volume. This transmission may be carried out by way of the SAN 120 and the WAN 160, or via the management server 190. The host 110 receiving this request switches the port 170 via which access to the relevant virtual logical volume had been performed up until this point to the port 170 sent in the relevant step. In accordance with this, because the host 110 is simply requested to change the port 170 (inside the same virtual storage system 150) for accessing the relevant virtual logical volume without changing the virtual storage system and the virtual logical volume, there is no discrepancy from the host's 110 perspective, and as such, the switchover goes smoothly. When there is no virtual storage system 150, the storage system 100 and logical volume to be accessed change when the accessing port 170 is transferred to a different storage system 100. Since this change affects the application program of the host 110, in this example, the introduction of the virtual storage system 150 makes it possible to adeptly change ports 170 and change the storage system 100, which receives the read/write request.

Step 14010: The processor 260 waits for completion reports.

Step 14011: The processor 260 totals the transfer latency time 4004 and the storage latency time 4005.

Step 14012: The processor 260 determines whether the total value of Step 14011 is sufficiently larger than the access time of the low-speed disk 290 (for example, larger than equal to or larger than a prescribed value). When this is not the case, the processor 260 jumps to Step 14004.

Step 14013: The processor 260 sets the low-speed disk 290 in the initial allocation storage 2010, turns ON the caching flag 2009, and jumps to Step 14000.

Step 14014: The processor 260 determines whether the total value of Step 14011 is sufficiently larger than the access time of the high-speed disk 265 (for example, larger than equal to or larger than a prescribed value). When this is not the case, the processor 260 jumps to Step 14006.

Step 14015: The processor 260 sets the high-speed disk in the initial allocation storage 2010, turns ON the caching flag 2009, and jumps to Step 14000.

Step 14016: The processor 260 determines whether the total value of Step 14011 is sufficiently larger than the access time of the flash package (for example, larger than equal to or larger than a prescribed value). When this is not the case, the processor 260 jumps to Step 14008.

Step 14017: The processor 260 sets the flash package 230 in the initial allocation storage 2010, turns ON the caching flag 2009, and jumps to Step 14000.

Step 14018: The processor 260 sets ineffective in the initial allocation storage 2010 and turns OFF the caching flag 2009. Thereafter, the processor 260 returns to Step 14000.

The host 110, which receives a query (the query sent in Step 14002) comprising the identifier of the virtual logical volume sent from the storage system 100, references the virtual logical volume ID 185 of the port information 180 of the host 110, and in a case where even one of the received virtual logical volume identifiers exists, notifies the query-source storage system of Step 14002 to the effect that this virtual logical volume is being accessed by the relevant host 110. This notification may be sent by way of the SAN 120 and the WAN 160, or via the management server 190.

Upon receiving the information (the information comprising the identifiers of the virtual logical volume and the port 170) (the information sent in Step 14009) sent from the storage system, the host 110 performs the following processing:

(1) Recognizes the received virtual logical volume and the port 170, which has been connected up to this point (there may be multiple ports 170), subtracts one from the number of virtual logical volumes 184 of the recognized ports 170, and deletes the corresponding virtual logical volume ID 185; and
(2) recognizes the number of virtual logical volumes 184 of the received port 170 identifier (there may be multiple identifiers), increases the corresponding number of virtual logical volumes 184 by one, and adds a corresponding virtual logical volume ID 185.

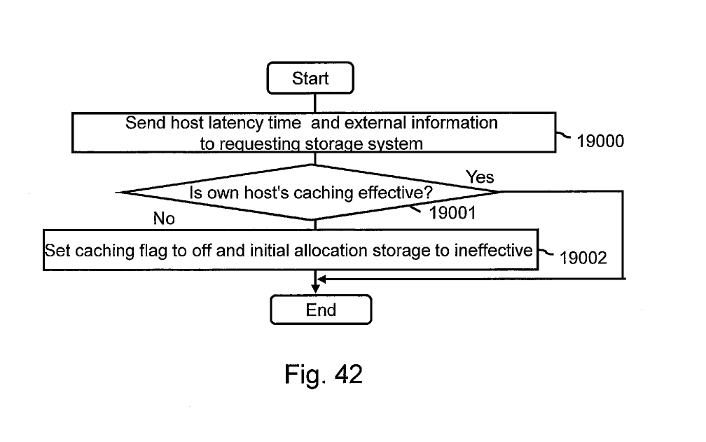

FIG. 42 is the flow of processing of the latency send part 4900. The latency send part 4900 is executed when information is sent from another storage system comprising the virtual storage system 150.

Step 19000: The processor 260 sends the storage system 100, which is the source of the request, the host latency time 4203 of the specified host 110.

Step 19001: The processor 260 references the sent information, and determines whether or not caching the specified virtual logical volume would be good for the relevant storage system 100. First, the processor 260 references the logical volume information 2000 and determines whether or not a logical volume corresponding to this virtual logical volume is included in the relevant storage system 100. In a case where this logical volume is included, the processor 260 compares the host latency time 4203 of the relevant storage system 100 to the latency time with the host 110, which has been sent from the request-source storage system 100, and in a case where the host latency time 4203 of the request-source storage system 100 is smaller than a certain range, determines that caching should not be performed for the relevant storage system 100. To avoid a discrepancy, this “certain range” has the same value as the “certain range” in Step 14008 of FIG. 34. In a case where this virtual logical volume is not included in the relevant storage system, the processor 260 compares the host latency time 4203 of the relevant storage system 100 to the sent latency time, and in a case where the host latency time 4203 of the relevant storage system 100 is larger, determines that caching should not be performed for the relevant storage system 100. In a case where the determination is not that (caching should not be performed) for the relevant storage system 100, the processor 260 ends the processing.

Step 19002: The processor 260 turns ON the caching flag 2009 corresponding to the identifier of the received virtual logical volume, and sets the initial allocation storage to ineffective.

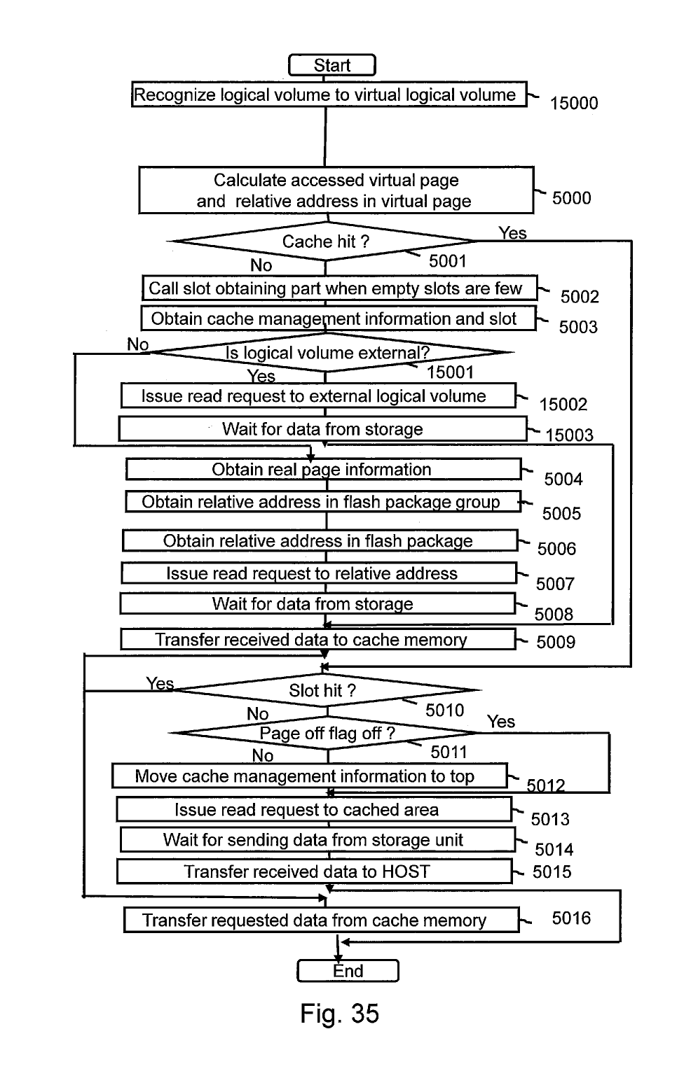

FIG. 35 is the flow of processing of the read process execution part 4000 in Example 2. The read process execution part 4000 is executed when the storage controller 200 receives a read request from the host 110. The differences with Example 1 will be described hereinbelow.

Step 15000: First, the processor 260 recognizes a logical volume on the basis of the virtual logical volume, which is the read target specified in the received read request. Thereafter, the processor 260 moves to Step 5000.

In the case of Example 2, the processing of Step 15001 and beyond starts subsequent to Step 5003.

Step 15001: At this point, the processor 260 identifies whether the logical volume is a logical volume of the relevant storage system 100 or a logical volume of another storage system 100. In the case of a logical volume of the relevant storage system 100, the processor 260 jumps to Step 5004.

Step 15002: The processor 260 issues a request for reading the requested data from the specified address of the specified logical volume, to the storage system 100, which has the specified logical volume.

Step 15003: The processor 260 waits for the data to be sent from the specified storage system 100. Thereafter, the processor 260 jumps to Step 5009.

These are the functions of the read process execution part of Example 2, which differ from Example 1.

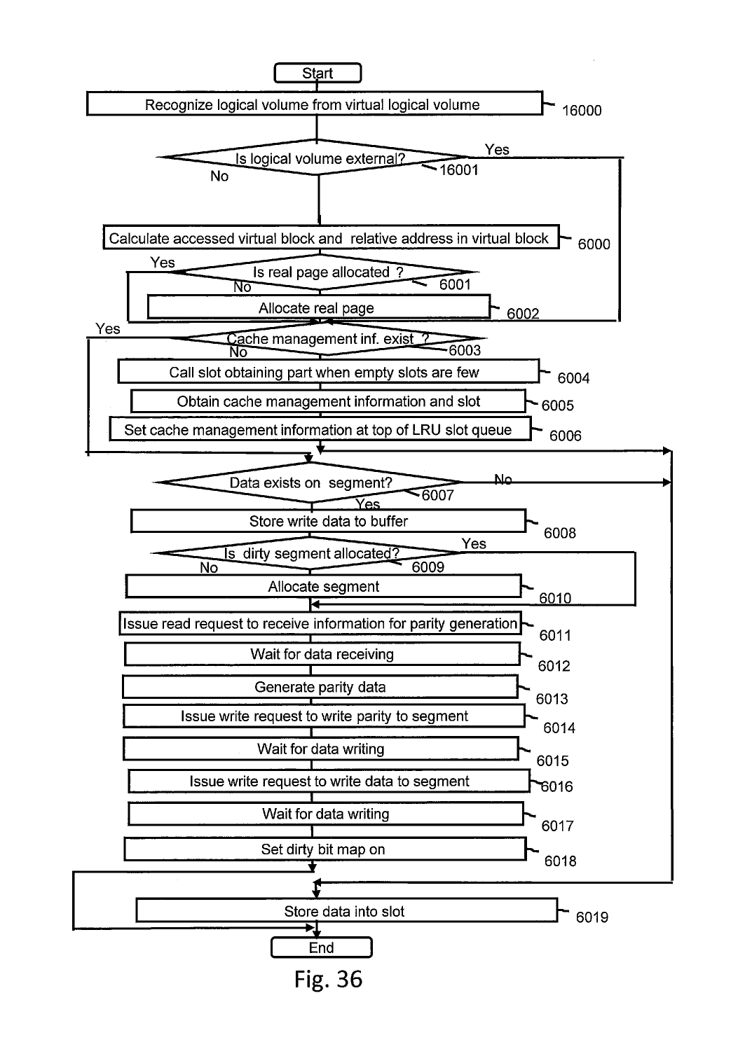

FIG. 36 is the flow of processing of a write request receive part 4100 of Example 2. The write request receive part 4100 is executed when the storage controller 200 receives a write request from the host 110. The differences with Example 1 will be described hereinbelow.

Step 16000: The processor 260 initially recognizes the specified logical volume on the basis of the virtual logical volume specified in the received write request.

Step 16001: The processor 260, in a case where the specified logical volume is a logical volume of the relevant storage system, jumps to Step 6000. In the case of a logical volume of another storage system 100, the processor 260 jumps to Step 6003.

These are the functions of the write request receive part 4100 of Example 2, which differ from Example 1.

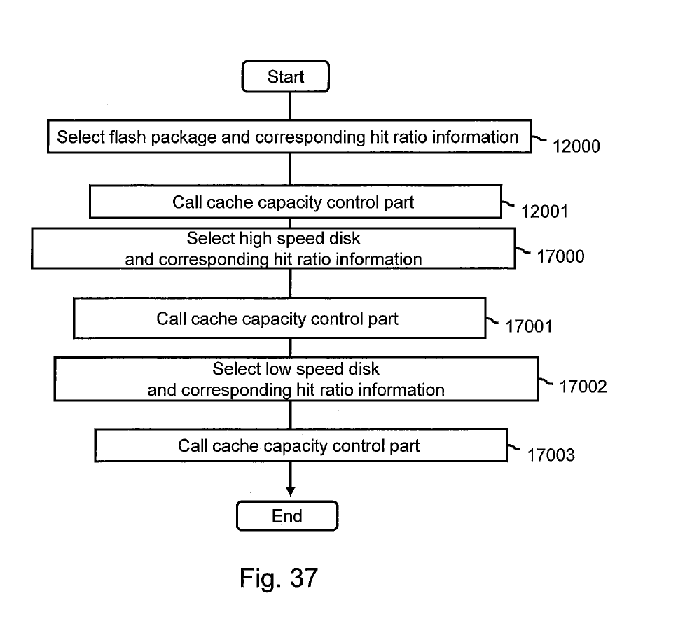

FIG. 37 is the flow of processing of the storage selection part 4700. The storage selection part 4700 is called by the transfer page schedule part 4400. In Example 2, the processing of Step 17000 and beyond is added subsequent to Step 12001.

Step 17000: At this point, the processor 260 selects a high-speed disk 265 and corresponding hit ratio information 2980. The processor 260 also sets information to the effect that the selected storage is a high-speed disk 265.

Step 17001: The processor 260 calls the cache capacity control part 4600.

Step 17002: At this point, the processor 260 selects a low-speed disk 290 and corresponding hit ratio information 2980. The processor 260 also sets information to the effect that the selected storage is a low-speed disk 290.

Step 17003: The processor 260 calls the cache capacity control part 4600.

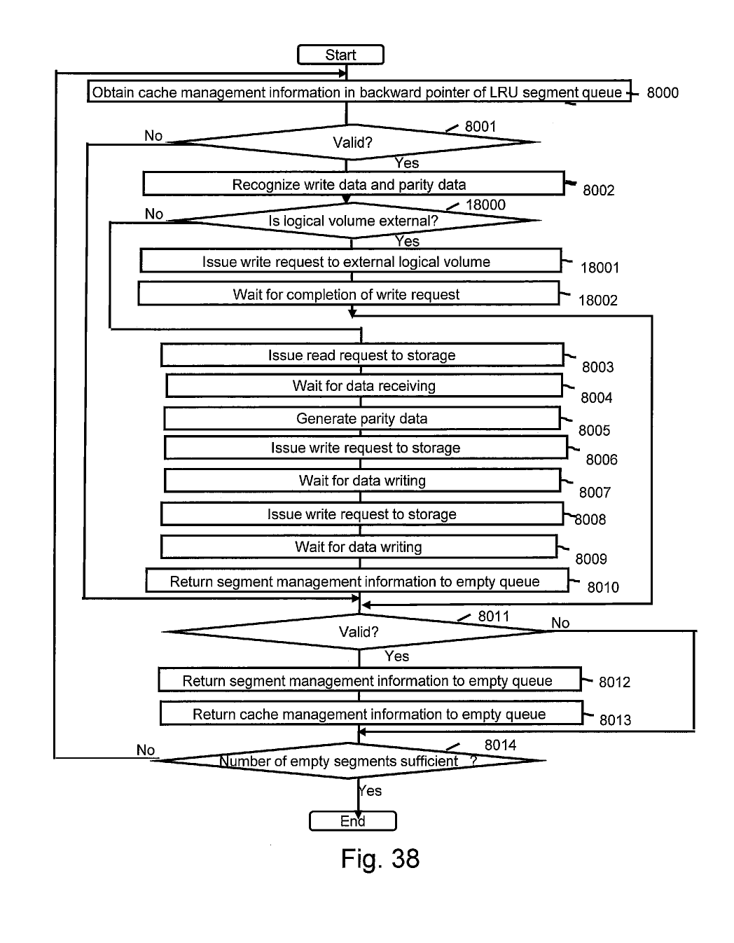

FIG. 38 is the flow of processing of the segment obtaining part 4300 of Example 2. The segment obtaining part 4300 is processing, which is executed by the processor 260 as needed. The segment obtaining part 4300 is called during processing, which is performed when a read request/write request has been received from the host 110, for increasing the number of empty segments 2920 in a case where the number of empty segments 2920 is equal to or less that a fixed value. The difference with Example 1 will be described hereinbelow.

The difference with Example 1 is that the following steps are executed subsequent to Step 8002.

Step 18000: At this point, the processor 260 identifies whether the logical volume is a logical volume of the relevant storage system 100 or a logical volume of another storage system 100. In the case of a logical volume of the relevant storage system 100, the processor 260 jumps to Step 8003.

Step 18001: The processor 260 issues, to the storage system 100, which has the specified logical volume, a request for writing the data shown in the dirty bitmap before parity generation 2756 to the specified address of the specified logical volume.

Step 18002: The processor 260 waits for a completion report from the specified storage system 100. Thereafter, the processor 260 jumps to Step 8008.

The transfer page schedule part 4400 shown in FIG. 24 is basically the same as that of Example 1.

However, the explanation of Step 10004 will be supplemented here. In Step 10004, when the processor 260 transfers data in a real page between different types of storage groups, the processor 260 decides the page of the transfer-source storage group and the transfer-destination storage group. In so doing, the transfer-destination storage group is decided in accordance with the following restrictions:

(1) Data in a real page allocated to the cache volume is not transferred to a real page based on a different type of storage group; and

(2) data in a real page allocated to the host volume, for which data caching is performed to a real page based on a storage group, is not transferred to a real page based on a flash package group 280.

In Example 2, caching is performed anew for a logical volume of a storage system 100 other than the relevant storage system 100. Therefore, the state in the above-mentioned (2) is the same as that of Example 1. Caching for a logical volume of a storage system 100 other than the relevant storage system 100 is done for any of a flash package 230, a high-speed disk, and a low-speed disk, but in this example, the configuration is such that data in a real page is not transferred between storage groups. Naturally, the present invention is effective in Example 2 even without the above-mentioned restrictions of (1) and (2).

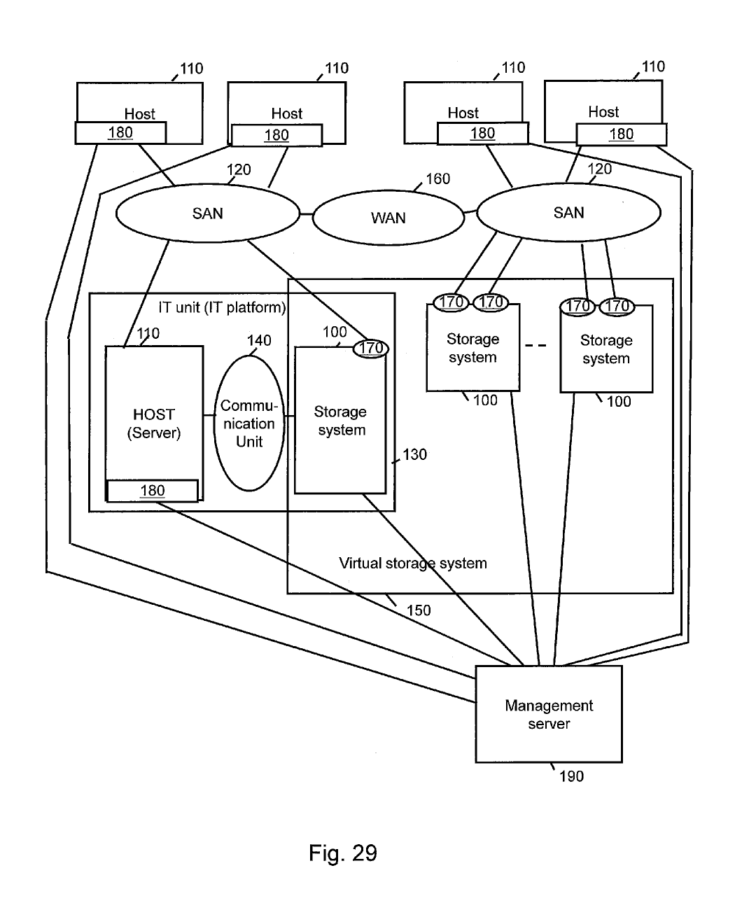

FIG. 29 is another configuration of the information system of Example 2.

The host 110 and the storage system 100 are mounted in a single IT unit (IT platform) 130, and are connected by way of a communication unit 140. The communication unit 140 may be either a logical unit or a physical unit. The present invention is effective in this configuration as well, and similarly is effective for the storage system 100 configuration and functions explained up to this point as well.

The following matters are derived in accordance with at least one of Example 1 and Example 2.

The storage system may be one of multiple storage systems constituting the basis of a virtual storage system, and the storage system, which provides the virtual storage system, may be a different storage system.

The storage system comprises two or more types of storages having different access performance, and a control apparatus, which is connected to these storages. The control apparatus comprises a higher-level interface device for the storage system to communicate with an external apparatus (for example, either a host apparatus or another storage system), a lower-level interface device for communicating with the above-mentioned two or more types of storages, a storage resource comprising a cache memory, and a controller, which is connected to these components and comprises a processor. Two or more of the same type of storages may be provided.

The control apparatus manages multiple storage tiers, and storages having the same access performance belong to one tier. The control apparatus manages a logical volume (for example, a logical volume, which conforms to Thin Provisioning) and multiple real pages. The logical volume may be a host volume or a cache volume, and both may be logical volumes to which the real pages are allocatable. The host volume is a logical volume specifiable in an access request from an external apparatus (that is, a logical volume, which is provided to an external apparatus). The cache volume is a logical volume in which data inside a host volume is cached, and is a logical volume, which is not specifiable in an access request from an external apparatus (that is, a logical volume, which is not provided to an external apparatus). A cache volume may be provided for each type of storage.

The real page may be based on a single storage, but typically may be based on a storage group comprising multiple storages having the same access performance (typically, a RAID (Redundant Array of Independent (or Inexpensive) Disks) group). The real page may also be based on a storage (for example, a logical volume based on one or more storages in another storage system) of a different storage system (an external storage system).

It is supposed that the storage having the highest access performance of the two or more types of storages is a memory package. The memory package may comprise a nonvolatile memory and a memory controller, which is connected to the nonvolatile memory and controls access from a higher-level apparatus (as used here, a control apparatus inside the storage system). The nonvolatile memory, for example, is a flash memory, and this flash memory is the type in which data is deleted in block units and data is written in sub-block units, for example, a NAND-type flash memory. A block is configured from multiple sub-blocks (generally called pages, but differ from the pages allocated to a logical volume).

The hit ratio may be a memory hit ratio, which is the hit ratio for the cache memory, or a volume hit ratio, which is the hit ratio for the cache volume.

The cache capacity, that is, the upper limit for the number of real pages used as a cache area, may be established. For example, when the control apparatus increases the cache capacity, the volume hit ratio increases, and in a case where the cache capacity reaches an upper limit value, the control apparatus may not increase the cache capacity (that is, may not increase the number of real pages used as the cache area).

Alternatively, the control apparatus may decide the number of real pages used as the cache area in accordance with the remaining number of empty real pages. The control apparatus preferentially allocates empty real pages to the host volume more than the cache volume. For example, in a case where the host volume unused capacity (the total number of virtual pages to which the real pages have not been allocated) is equal to or larger than a prescribed percentage of the empty capacity (the total number of empty real pages), the control apparatus may designate the remaining empty real pages for host volume use, and need not allocate remaining empty real pages to the cache volume. Alternatively, usable real pages from among multiple real pages may be predetermined as a cache area, and empty real pages falling within this range may be allocated to the cache volume.

The control apparatus also selects a real page, which is based on a storage with a higher access performance than the performance of the storage storing access-target data, as the caching-destination real page of the access-target data stored in the host volume (the data conforming to an access request from the host). Therefore, for example, the control apparatus, in a case where the access-target data is stored in a memory package-based real page allocated to the host volume, does not select a memory package-based real page as the caching destination of the access-target data. That is, for example, in this case the control apparatus may use only the cache memory rather than both the cache memory and the real page as the caching destination of the access-target data.

However, in the case of a virtual storage system (a combined storage system), the control apparatus may select a real page based on a storage with either the same or lower access performance than the performance of the storage (the second storage system) storing the access-target data on the basis of the latency time (length of transfer time) for communications between the host and the first storage system comprising this control apparatus, and the latency time (length of transfer time) for communications between the first storage system and the second storage system, which is storing the access-target data.

The control apparatus, in a case where either a read request or a write request has been received from the host apparatus, determines whether or not there was a hit (whether a cache area was able to be obtained) for the cache memory earlier than for the cache volume, and in the case of a miss, determines whether or not there was a hit for the cache volume.

For example, when multiple real pages used as the cache area are based on the same storage, accesses focus on this storage, resulting in this storage becoming a bottleneck. Consequently, to avoid this, the control apparatus transfers the data in the real pages between storages (between storage groups). In so doing, in a case where the real pages are based on flash package groups, the control apparatus receives the number of deletions from each memory package, and transfers the data in the real pages so that the number of deletions of the flash package groups becomes as uniform as possible. For example, in a case where there is a first flash package group with a large total number of deletions, and a second flash package group with a small total number of deletions, the control apparatus transfers the data in the cache area (real pages) based on the first flash package group to real pages based on the second flash package group. This makes it possible to realize both load leveling and the equalization of the number of deletions. That is, since the flash package group constituting the basis of the real pages (cache area) for which the rewrite frequency is considered to be higher than the non-cache area real pages changes from the first flash package group to the second flash package group, the number of deletions can be expected to be equalized. In so doing, it is preferable that the transfer source be the real page with the highest access frequency of the multiple real pages based on the first flash package group, and the transfer destination be the real page with the lowest access frequency of the multiple real pages based on the second flash package group.

The control apparatus also exercises control so as not to transfer the data in the real pages used as the cache area to real pages based on a storage with access performance identical to (or lower than) the access performance of the storage forming the basis of these real pages.

In the case of the virtual storage system, the host computer comprises port information, which is information comprising access-destination information (for example, the port number of the storage system) capable of being specified in an access request issued by this host computer. A management computer (for example, the management server 190 of Example 2) restricts for each host the access destination information described in the port information of this host to information related to the port(s) of the storage system, from among the multiple storage systems comprising the virtual storage system, for which the distance from this host is less than a prescribed distance (for example, the response time falls within a prescribed time period). In other words, as the storage system capable of being used by the host as an access destination, the management computer does not select a storage system, which is located at a distance equal to or larger than a prescribed distance from this host (for example, the management computer does not list a port ID which this host must not select from the port information 180 of the host (or, for example, lists the IDs of all the ports of the virtual storage system, and invalidates only the port IDs, which will not be valid)).

The control apparatus may suspend caching to the cache volume in a case where the volume hit ratio is less than a prescribed value. In so doing, the control apparatus may transfer the data in the real page already allocated to the cache volume to the cache memory and release this real page, or may release this real page without transferring the data in this real page already allocated to the cache volume to the cache memory. The control apparatus may also reference the cache management information in the common memory, and may resume caching to the cache volume when the memory hit ratio has increased.

The control apparatus, which receives an access request from the host, may select a storage to be the basis of the caching-destination real page based on a first latency time (transfer time) from the first storage system, which is the storage system comprising this control apparatus in the virtual storage system, and the second storage system, which is storing the access-target data.

The control apparatus in the first storage system may also select a storage to be the basis of the caching-destination real page based on a second latency time with the host, which is connected to the respective storage systems of the virtual storage system, in addition to the first latency time.

The control apparatus (or a virtual computer) may change the access-destination storage system of the host (for example, may rewrite the access destination information in the port information of this host).

The control apparatus may adjust (either increase or decrease) the number of real pages capable of being used as the cache area in accordance with the volume hit ratio. The volume hit ratio may be measured by type of storage.

The control means may measure a degree of congestion, such as the access status of the real page (or a virtual page, which is the allocation destination of the real page), decide a transfer-source and a transfer-destination real page based on the degree of congestion of the real pages, and transfer data from the transfer-source real page to the transfer-destination real page between either same or different types of storages.

A number of examples have been explained hereinabove, but the present invention is not limited to the above-described examples.

### REFERENCE SIGNS LIST

100 Storage system
110 Host
120 Storage area network (SAN)
140 Communication unit
150 Virtual storage system
160 World area network (WAN)
170 Port
180 Port information
200 Storage controller
210 Cache memory
220 Common memory
230 Flash package
265 High-speed disk apparatus
290 Low-speed disk apparatus
240 Timer
250 Connection unit
260 Processor
270 Memory
280 Flash package group
285 High-speed disk group
295 Low-speed disk group
2050 Storage system information
2000 Logical volume information
2100 Real page information
2300 Storage group information
2500 Storage information
2750 Cache management information
2760 Slot management information
2850 Segment management information
4010 Virtual storage system information
4110 External logical volume information
4210 Host information
4000 Read process execution part
4100 Write process receive part
4200 Slot obtaining part
4300 Segment obtaining part
4400 Transfer page schedule part
4500 Real page transfer process execution part
4600 Cache capacity control part
4700 Storage selection part
4800 Caching judge processing part
4900 Latency send part

1. A storage system connected to a host, comprising:
two or more types of storage systems having different performances; and
a control apparatus, which is connected to the two or more types of storages and the host,
wherein the control apparatus:
(A) partitions one or more storages of the same type into multiple real pages, and provides the host with a host volume, which is a logical volume comprising multiple virtual pages to which the real pages are respectively allocatable, and which is specified by an access request from the host; and
(B) uses one or more real pages of the multiple real pages as a cache area of the host volume.

2. A storage system according to claim 1, wherein the control apparatus:
(C) measures a cache hit ratio of the storage; and
(D) adjusts the number of real pages used as the cache area on the basis of the measured hit ratio.

3. A storage system according to claim 2, wherein the control apparatus measures the hit ratio for each type of the storages in the (C), and the control apparatus adjusts the number of real pages used as the cache area for each type of the storages in the (D).

4. A storage system according to claim 3, wherein the control apparatus:
(E) measures an access status of the real page; and
(F) transfers data, which is in the real page, between storages of either the same type or different types on the basis of the access status of the real page and the performance of the storage, which is the basis of the real page.

5. A storage system according to claim 1, wherein the control apparatus manages a cache volume, which is a logical volume to be an allocation destination of the page used as the cache area.

6. A storage system according to claim 5, wherein the control apparatus:
(E) measures the access status of the real page; and
(F) transfers data, which is in the real page between storages of either the same type or different types on the basis of the access status of the real page and the performance of the storage, which is the basis of the real page.

7. A storage system according to claim 6, wherein the page to be the target of the (F) is a page allocated to the host volume and is not a page allocated to the cache volume.

8. A storage system according to claim 5, wherein the cache volume exists for each type of the storages.

9. A storage system according to claim 1, wherein the page used as the cache area is a page based on a storage having a higher performance than the storage constituting the basis of the page which is allocated to the host volume and is a data storage destination.

10. A storage system according to claim 1, wherein the two or more types of storages comprise two or more flash packages, each having a flash memory comprising multiple blocks, which are data deletion units, and
(G) the control apparatus measures the number of deletions of each flash package, and
the control apparatus transfers data, which is in the page, between the flash packages based on the number of deletions in the (F).

11. A storage system according to claim 1, wherein the control apparatus shares an identifier of a virtual storage system comprising multiple storage systems, with other storage systems of the multiple storage systems which is a combined storage system,
the host volume constitutes the basis of a virtual logical volume, and the control apparatus:
(H) recognizes the storage system of which logical volume is the virtual logical volume;
(I) recognizes a latency pursuant to transferring data to another storage system, which belongs to the combined storage system; and
(J) caches the data of the other storage system belonging to the combined storage system, in the page in accordance with the recognized latency.

12. A storage system according to claim 11, wherein the control apparatus selects a caching-destination storage from among the two or more types of storages, in accordance with the recognized latency.

13. A storage system according to claim 11, wherein in the (I), the control apparatus recognizes a transfer latency time with the host, which is connected to each storage system of the combined storage system, and in the (J), the control apparatus caches the data of the other storage system belonging to the combined storage system in accordance with the recognized latency.

14. A combined storage system, which comprises multiple storage systems, wherein the multiple storage systems share an identifier of a virtual storage system and provide a virtual logical volume, and
each storage system:
(A) recognizes the storage system of which logical volume is the virtual logical volume;
(B) recognizes a latency pursuant to transferring data to another storage system, which belongs to the combined storage system; and
(C) caches the data of the other storage system belonging to the combined storage system, in accordance with the recognized latency.

15. A combined storage system, which comprises multiple storage systems, wherein the multiple storage systems share an identifier of a virtual storage system, provide a virtual logical volume, and include a first storage system,
each storage system comprises a storage, and
the first storage system:
(A) partitions one or more storages of the same type into multiple real pages and provides the host with a host volume, which is a logical volume comprising multiple virtual pages to which the real pages are respectively allocatable, and which is specified by an access request from the host; and
(B) uses the page of the storage as a cache for storing data of another storage system comprising the combined storage system.
